(19) United States
(12) Patent Application Publication
(10) Pub. No.: US 2012/0006084 A1
(43) Pub. Date: Jan. 12, 2012

(54) ELECTRONIC ARTICLE SECURITY SYSTEM

(76) Inventor: Paul Joseph Weber, Queenstown (NZ)

(21) Appl. No.: 12/867,919

(22) PCT Filed: May 28, 2009
(86) PCT No.: PCT/NZ09/00084

§ 371 Date: Jun. 24, 2011

(30) Foreign Application Priority Data
Jun. 23, 2008 (AU) 2008202749
Aug. 21, 2008 (AU) 2008207441

(51) Int. Cl. E05B 73/00; E05B 17/00

(52) U.S. Cl. 70/466; 70/431

(57) ABSTRACT

Disclosed are embodiments of apparatus, methods, and systems for securing electronic articles, such as computers, for theft deterrence or prevention. In one embodiment, a body is provided, which is secured to an intermediary structure. The intermediary structure is, in turn, secured to the electronic article. The body may be configured as a mass such that it is of sufficient weight, shape, and/or size to allow for deterring theft. In some embodiments, the system is configured to render inaccessible, or at least impede access to, at least one piece of fastening hardware between the intermediary structure and the body and/or between the intermediary structure and the electronic article, thereby further deterring theft.

### TECHNICAL FIELD

The present invention is directed toward apparatus, methods, and systems for securing electronic articles, such as computers, for theft deterrence or prevention.

### BACKGROUND

Electronic articles such as personal computers, laptop computers, gaming consoles etc can be attractive target for thieves stealing from homes or vehicles. Electronic articles (EAs) including personal computers (PC) have traditionally been made secure by many means which have included locks, cables, partial housings, complete housings. Such articles have also previously been fastened (screwing, bolting, nailing) to immovable objects, such as floors, tables, and stands. Each form of security has its drawbacks.

### SUMMARY

According to one aspect to the present invention there is provided a system for securing an electronic article, the system comprising: a moveable body; an intermediary structure adapted to enable an electronic article to be secured to the body; and a coupling mechanism to enable the body to be secured to an external fixture, wherein the body is shaped to inhibit unauthorized decoupling from the external fixture of the mass and secured electronic article.

It should be understood that any references herein to a personal computer, laptop computer, or other specific electronic article, may be considered to apply, unless otherwise specified, to any other electronic article, such as a stereo system, gaming console, etc.

### BRIEF DESCRIPTION OF THE DRAWINGS

Understanding that drawings depict only certain preferred embodiments of the invention and are therefore not to be considered limiting of its scope, the preferred embodiments will be described and explained with additional specificity and detail through the use of the accompanying drawings in which:

FIG. 1 is a front elevation view of an embodiment of the invention in which a personal computer is secured to an intermediary that is, in turn, secured to a mass.

FIG. 2 is a cross-sectional view taken along line 2-2 of FIG. 1.

FIG. 3 is a front elevation view of another embodiment of the invention in which the personal computer is secured in an overhanging fashion to an intermediary structure to give the illusion of a “floating PC.”

FIG. 4 is a side elevation view of the embodiment of FIG. 3.

FIG. 5 is a front elevation view of still another embodiment of the invention in which a personal computer is secured to a slidable intermediary structure.

FIG. 6 is a side elevation view of the embodiment of FIG. 5.

FIG. 7 illustrates some examples of non-standard drive socket screw/bolt head shapes for added security.

FIGS. 8A-8E depict cross-sectional views of various other embodiments of the invention.

FIG. 9 depicts an embodiment of an intermediary structure including teeth to provide further theft deterrent.

FIG. 10 depicts another embodiment of an intermediary structure including a variety of internal modifications and armaments, including a motion sensor, central processing unit, battery, and alarm.

FIG. 11 depicts a cutaway view of yet another embodiment of the invention that includes a laptop computer secured to an intermediary structure comprising a locked metallic cage, which is, in turn, secured to a mass.

FIG. 12 depicts an embodiment comprising a mold kit for creating a mass

FIG. 13 depicts a perspective view of an embodiment of a coupling mechanism for connecting a mass to a fixed, external surface, such as a seat rail bolt/anchor point area in a vehicle.

FIGS. 14A-E depict cross-sectional views of various other embodiments of the invention that includes a laptop computer secured to an intermediary structure comprising a lockable metallic cage. FIG. 14A is a top cross sectional view in yet another embodiment of the invention. FIG. 14B is a side cross-sectional view of the embodiment of FIG. 14A. FIG. 14C is a top cross sectional view of the side restraint and outer protective alloy. FIG. 14D is an oblique cross sectional view of the side restraint and outer protective alloy. FIG. 14E is a side non-elevation/declination view of a protective alloy shaped to protect a “side” restraint.

FIG. 15A is an exploded perspective view of an embodiment of an intermediary structure comprising two L-shaped side restraints, one of which comprises two projections configured to be received in two corresponding openings in the other.

FIG. 15B a cross-sectional side elevation view of the intermediary structure of FIG. 15A, shown with the two L-shaped side restraints engaged together.

FIG. 15C is an example of a further embodiment of the invention adapted for a laptop computer or case.

FIG. 16A-C illustrate various components of a further embodiment of the invention.

FIG. 17 illustrates an example of a further embodiment of the invention.

### DETAILED DESCRIPTION OF PREFERRED EMBODIMENTS

In the following description, numerous specific details are provided for a thorough understanding of specific preferred embodiments. However, those skilled in the art will recognize that the invention can be practiced without one or more of the specific details, or with other methods, components, materials, etc.

In some cases, well-known structures, materials, or operations are not shown or described in detail in order to avoid obscuring aspects of the preferred embodiments. Furthermore, the described features, structures, or characteristics may be combined in any suitable manner in one or more embodiments.

Described herein are various embodiments of apparatus, methods, and systems for securing electronic articles, such as computers, for theft deterrence or prevention.

Embodiments of the present invention provided a system for securing an electronic article, the system comprising a moveable body or mass 130, 330, 1130, an intermediary structure 120, 320, 1120, and a coupling mechanism 392-394, 1490-1491. The intermediary structure 120, 320, 1120 is adapted to enable an electronic article 110, 310, 1111 to be secured to the mass. The coupling mechanism 392, 394, 1490, 1491 is adapted to enable the mass to be secured to an external fixture. The mass 130, 330, 1130 has significant height, width and depth to inhibit unauthorized decoupling from the external fixture of the mass and secured electronic article.

In some embodiments the height, width and depth of the mass adds significant bulk to the secured electronic article. For example, when coupled to the external fixture, the bulk can inhibit relative movement between the external fixture and the mass to inhibit unauthorized decoupling from the external fixture. Alternatively, when coupled to the external fixture, the bulk inhibits access to the coupling mechanism to inhibit unauthorized decoupling from the external fixture.

In some embodiments the coupling mechanism comprises a first coupling integral with the mass and a second coupling attachable to the first coupling and the external fixture. The first coupling can include a fastener which is cooperative with the second coupling. For example, the first coupling fastener can be an eyebolt 392 fixed in the mass and the second coupling is adapted to permanently or removably attach the eyebolt 392 to the external fixture whereby the electronic article is secured to the external fixture 393. For example the second coupling can be an irreversible fastener such as one or more chain links. Alternatively the second coupling can be a lock 394. One example of an external fixture is an eyebolt 393 fixed to a floor, wall, or permanently fixed furniture. In another example, the external fixture is a seat rail in a vehicle.

In some embodiments of the system the intermediary structure 120 comprises a first surface 162 adapted to be secured to the body or mass using at least one first fastener, and a second surface 161 adapted to be secured to an electronic article using at least one second fastener in a manner which inhibits unauthorized removal of the secured electronic article without damaging the electronic article. The intermediary structure can be configured to impede access to both the first and second fasteners when the movable mass and electronic article are secured to the first and second surfaces respectively. Such embodiments are advantageously suited for securing electronic articles which are not regularly moved, such as desktop PCs, stereos and gaming consoles.

In some embodiments of this intermediate structure, the first surface includes one or more first holes and the second surface includes one or more second holes wherein at least one of the one or more second holes is aligned with at least one or more first holes.

In an embodiment the intermediary structure is configured to allow the electronic article to be moved relative to the body or mass.

In some alternative embodiments the intermediary structure 1120 comprises at least one securing member and the body 1130 includes a cavity configured to receive at least part of the intermediary structure and at least part of the electronic article 1111. At least one securing member of the intermediary structure 1120 is secured to the body 1130 within the cavity using a binding mechanism 1191 whereby the presence of the electronic article within the cavity renders the binding mechanism inaccessible, and wherein the intermediary structure is adapted to releasably secure the electronic article within the cavity.

In some embodiments the intermediary structure includes two or more side restraints 1121 which are lockable 1123 to form a cage to secure the electronic article within the cavity. The side restraints can be collapsible such that they may be selectively extended above the movable body.

Embodiments of the system can further comprise a security component for further deterring theft of the electronic article. For example the security component can comprise at least one or more of: a motion sensor; a camera; an electronic ignition; a transmitter; a detector; and an alarm. The intermediary structure of some embodiments includes a hollow structure and wherein the security component is disposed within the hollow structure of the intermediary structure.

The crowbar is one of the most common tools of a would-be thief. Most methods of securing an electronic article are often rapidly overcome by a crowbar and yet may leave the article saleable at the conclusion of the theft. Herein is presented devices, methods, and systems for gravitationally securing, for example, a personal computer, that are not easily defeated by a crowbar unless the thief is willing to severely damage the casing ‘box’ of the computer, thereby drastically reducing the pawn value of the PC. In some embodiments, the theft deterrence is provided by securing the electronic article(s) to an object that makes the task of moving the article more difficult for a would-be thief. In some embodiments, the connection between the electronic article(s) and the object (hereinafter referred to as a “mass”) is facilitated by providing an intermediary structure. Some embodiments of the invention utilize tubes and/or extrusions to make hidden from view, and inaccessible to a thief, fastening hardware, while creating attachments of maximal strength between a personal computer and a mass. In some embodiments, the article could only be removed from the mass if a would-be-thief were carrying specialized tools. Thus, with only standard burglar tooling, such as crowbar, screwdriver, knife, bolt-cutters, pliers, etc., some embodiments would deter theft by requiring substantial amounts of time and/or effort to detach the article for transport. Otherwise, the PC could only be removed by destroying it beyond practical salability or by significant physical effort if the computer was to be moved over a substantial distance without a dolly or wheeled cart.

Some embodiments of the present invention provide for the fastening of a preformed, geometrically shaped, body or mass, usually made of mineral, directly or indirectly with an electronic article or articles. The body may, in some preferred embodiments, be made up of a piece of formed cement or concrete, cut stone, metals such as iron or lead, or the like. In other embodiments, the body may instead, or additionally, be made up of dense wood, dense plastic, and/or glass.

Various embodiments may also elevate the PC off of the floor by several inches and thereby offers some additional advantages, which include improved ventilation, improved cooling, reduced dust capture, slideable rear or side access provision, and reduced flood or water damage potential in the case of natural disaster, nearby water pipe burst, or continual daily wet mopping.

In some embodiments, an intermediary structure is also provided to facilitate the connection between the body and the article. The intermediary structure may allow for the electronic age to meet the Stone Age. In other words, because the manufacturing tolerances involved in placing high-strength fasteners in stone/concrete work have previously been too large to allow in practical useful combination with articles of electronic manufacture such as PC, the intermediary structure may allow a user to combine the two technologies and tolerance ranges.

In some embodiments, the body may have external areas of attachment available to place one or more fasteners which may be further linked by a lock to another object to reduce the ability to move the body. These other objects may include, but are not limited to, eyebolts, eyescrews, or other fastening devices, which may be, in turn, attached to a floor or wall. In some embodiments, the body may be weighted so as to be sufficiently light so as to be liftable by a physically fit adult human, but sufficiently heavy such that such an individual could only lift the body for only a few moments comfortably. Other embodiments are contemplated in which the mass is sufficiently heavy such that no human could lift the mass without assistance from a transport device, such as a dolly or cart.

The intermediary structure in some embodiments may be hollow and may also be metallic. However, the intermediary structure may also be mineral-based, plastic, glass, or wooden. The EAs may comprise PC, but, alternatively, may be peripheral devices, such external hard drives or battery back-ups. The unified combination of the mass, intermediary structure, and PC may be situated on the floor, but may instead sit upon a sturdy table, desk, or the like. The EA is usually positioned upright on the other structure(s) and thus the base of the EA may be fastened to the top of the intermediary structure. Such a combination usually elevates the EA off of the floor by several inches and offers some additional advantages, as mentioned above.

The intermediary structure may be have secondary uses such as acting as a housing for sensors (motion, sound activated, magnetic, electronic, wired, or wireless), detectors (GPS, smoke, or heat), alarms (sounding or silent), lights (decorative or warning, such as strobe, flashing or colored), gas/vapor/aerosol emitters (such as fire retardant, noxious smell (such as butyric acid), toxic emitters (including nerve gas, mace, pepper-capsaiciniods such as capsaicin and smoke)). The intermediary structure may also contain a cellphone or other transmitter, receiver, or transceiver that may transmit information regarding the attempted theft to a user and/or a centralized security system location. The intermediary structure may also house other defensive or offensive measures or countermeasures, which may include smoke bombs, stink bombs, rasps, barbs, etc. Other security features may be included in the intermediary structure, including batteries, alarms, flashing lights, smell emitters, fixed or moveable sharp teeth or points, pointed objects, projectiles, materials or devices capable of generating a shock wave, mouse traps, GPS, motion sensor, electromagnetic spectral sensor, electrical capacitor for electric shock (especially the teeth modification), fire extinguisher, physical storage, hiding place, finger print surface retainer, perpetrator marking paint, smoke bomb holder, tear gas holder, capsaiciniods (such as capsaicin or mace reservoir), and/or speaker (preprogrammed with phrases such as “Help, Police, I'm being stolen,” “Stop Thief,” etc.).

Amenities can also be incorporated into or attached to the body or mass, such as protective and/or decorative carpet or other materials, paint, a sticker, or a sign with a message such as “Help, I'm being stolen,” a pressure sensor, communications, etc.

In one implementation of a method for securing an electronic article according to the invention, a heavy, moveable mass is formed to facilitate securing the mass to an intermediary structure. The mass is secured to the intermediary structure and an electronic article is secured to the intermediary structure. The mass may be configured such that it is sufficiently heavy to deter theft of the electronic article once the mass has been connected with the electronic article, yet sufficiently light to allow for the electronic article to be moved once the mass has been connected with the electronic article. In some embodiments, the mass may be movable, although with great effort required, by an average adult human. In other embodiments, the mass may only be movable with a dolly, wheeled cart, or other such device. A preferred weight range for the mass is between about 5 kg and about 60 kg. Any of the various masses described herein are examples of means for deterring theft of an electronic article by adding weight to the electronic article. In addition, or alternatively, the mass may be of a size and/or shape that makes it awkward to transport. In such embodiments it is the bulk of the mass rather than the weight of the mass which inhibits theft of the secured electronic article. Further, the time and effort required to remove the electronic article from the mass or to remove the mass and electronic article in combination acts as a further deterrent to theft.

In other embodiments, the mass may have external areas of attachment available to place one or more fasteners which may be further linked by a lock or locking mechanism to another object to reduce the ability to move the mass. Examples of such other objects may include, but are not limited to, eyebolts, eyescrews, or fastening devices, which may be, in turn, attached to a floor or a wall, for example.

In one embodiment of a system for securing an electronic article according to the invention, an electronic article is connected with a heavy, moveable mass with an intermediary structure secured and interposed therebetween so as to facilitate a secure connection between the electronic article and the mass. Any of the various intermediary structures disclosed herein are examples of means for facilitating a secure connection between an electronic article and a means for deterring theft.

In some embodiments, the intermediary structure may be configured to facilitate a more precise connection with the electronic article than with the mass. For example, if the mass is formed from concrete and the intermediary structure is formed from aluminum, it is well known that aluminum can facilitate a connection with a fastening member within a much tighter tolerance range than concrete. The mass may comprise, for example, one or more of aluminum, basalt, brick, carbon, cement, copper, chromium, concrete, limestone, dolomite, glass, gold, granite, iron, lead, limestone, marble, nickel, porcelain, quartz, tin, sandstone, steel, stone, uranium, and zinc. The mass is preferably made from a dense material. In preferred embodiments, the density of the mass material is between about 1,800 and 20,000 kg/meter cubed. In other embodiments, the density of the mass material is between about 800 and 1,800 kg/meter cubed.

In some embodiments, the mass may include a recessed region within at least a portion of the mass. The recessed region may be shaped and configured to receive the intermediary structure. In other words, the intermediary structure and/or electronic article may sit recessed within the mass with respect to a top surface of the mass if desired.

In some embodiments, the intermediary structure may be formed so as to facilitate connection with the electronic article. Similarly, the intermediary structure may be formed so as to facilitate connection with the body or mass. For example, one or more first holes may be formed in a first surface of the intermediary structure, and one or more second holes may be formed in a second surface of the intermediary structure. The first surface may be configured to be positioned adjacent to the electronic article and the second surface may be configured to be positioned adjacent to the body or mass. At least one of the one or more second holes may be aligned with at least one of the one or more first holes to allow a user to have access to the second surface during the process of attaching the intermediary structure to the mass.

In some embodiments, the second holes may be larger than the first holes so as to facilitate securing the second surface of the intermediary structure to the mass and the first surface of the intermediary structure to the electronic article. In some embodiments, the intermediary structure may comprise a hollow structure to allow for access to a first wall secured to the electronic article and to a second wall secured to the mass. In some embodiments, one or more added security components for further deterring theft of the electronic article may be included, such as motion sensors, cameras, electronic ignition devices, transmitters, detectors, alarms, etc. These security components may be secured to the intermediary structure. In embodiments in which the intermediary structure comprises a hollow structure, the security component may be secured to the intermediary structure within a hollow region of the intermediary structure so as to make these components inaccessible, or less accessible, to thieves.

The following definitions reflect the standards of related arts. Bolts: bolts are defined as headed fasteners having external threads that meet an exacting, uniform bolt thread specification (such as M, MJ, UN, UNR and UNJ) such that they can accept a non-tapered nut.

Screws: screws are defined as headed, externally threaded fasteners that do not meet the above definition of bolts.

Polymeric concrete: Uses binders, compounds and aggregate mixtures, including epoxy, polyester, vinyl ester, and other polymer resin bonds. They cure or set through chemical reactions, thermoset bonds, and/or multiple component binder systems.

Extrusion (metalworking): The conversion of a billet of metal into a length of uniform cross section by forcing the billet through orifice of a die. An example of a simple and convenient metal for use in this area is aluminum.

Fastener: a hardware device that mechanically joins or affixes two or more objects together.

Reversible fastener: an object or a pair of objects (such as a male-female type in a screw/bolt-nut combination) intended to bind a plurality of objects together but may be reversed or unfastened without destroying or permanently altering any of the bound or binding objects. Other examples of reversible fasteners that are not paired and not male-female include cotter pins, and obstructive/protruding-portion fasteners, such as spring-loaded ball-tipped pin fasteners.

Irreversible fastener: an object or a plurality of objects intended to bind a plurality of objects together but may not be reversed or unfastened without destroying or permanently altering any of the bound or binding objects. Examples of irreversible fasteners include pop rivets, rivets, expansion inserts (including those that are screw activated and impact activated), glues, epoxies, gums, resins, etc.

Concrete fibers: fibers put into concrete to enhance strength and form.

Lock Washer: a substantially planar object, usually metallic, with a central opening that is larger than the threaded diameter of a screw/bolt that passes through it but smaller than the head of the screw/bolt or nut made adjacent. As opposed to a regular washer, a lock washer is usually selected to be not much larger in diameter than the outermost diameter of the bolt head or nut that it is intended to lie adjacent. The effect of a lock washer is to place axial pressure on the head of a bolt or nut to reduce vibration or stress induced un-tightening.

Mineral: any material that is not animal or vegetable in nature.

Natural rock: occurring in nature; not unnatural or man-made (like cement or concrete).

Nut: a type of hardware fastener with a threaded hole. Nuts are typically used opposite a mating bolt to fasten a stack of parts together. The two partners are kept together by a combination of their threads' friction, a slight stretch of the bolt, and compression of the parts. In application where vibration or rotation may work a nut loose, adhesives, safety pins, and/or other methods may be used to prevent fastener rotation.

Rivet: a mechanical fastener which before installation consists of smooth cylindrical shaft with a head on one end. The opposing end is called the buck-tail. On installation, the rivet is placed in a pre-drilled hole. Then the tail is upset or deformed so that it expands to about 1.5 times the original shaft diameter and holds the rivet in place. Rivets tolerate shear load (loads perpendicular to the axis of the shaft) better, whereas bolts and screws are better suited for tension applications (loads parallel to the axis of a shaft).

Synthetic Rock: Hardened material, usually comprised substantially of substances found in types of stone or rock that is bound by additional input/work from man, including those ingredients found in concrete or cement. Ground rock bound together by epoxy or plastics or glues may also qualify.

Screw/bolt: a threaded object usually acting in the male sense, that is inserting into a recipient object, such as a nut or female recipient threaded insert for the purpose of fastening a plurality of objects that lie between the ends of the female and male ends.

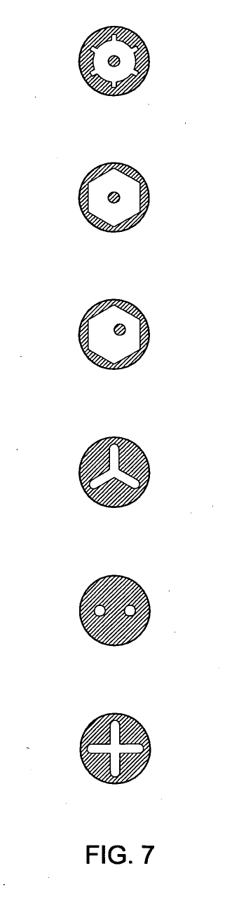

Socket Screw: a screw or bolt with a depression or centralized deformity (socket) in the head that is designed to fit/match a special “key”-shaped socket driver, often hexagon shaped. However, uncommon shapes (security shapes, see FIG. 7) may be desired to further thwart theft attempts.

Threaded insert: A female object (often metallic), with inner diameter recipient threads intended to receive a matching a male object, such as a bolt or screw. The threaded insert may be attached into an object, for example, in concrete by placing the insert in the concrete prior to hardening. A threaded insert may also be placed into an already hardened object by drilling a hole in the object that is slightly larger, e.g., by 1-2 mm (if there is no protruding base edge), than the outer diameter of the threaded insert and placing epoxy or an acrylate glue (cyanoacrylate, methacrylate, methylmethacrylate, for example) into the hole and then placing the insert into the hole.

Washer: a substantially planar object, often metallic, with a central opening that is larger than the threaded diameter a screw/bolt that passes through it but smaller than the head of the screw/bolt or nut made adjacent. The effect of the washer is to distribute the force per square unit area of the fastening device. The shape of a washer when viewed from the top is traditionally circular or square, but may take on any geometric shape for the purposes of this disclosure.

It should be appreciated that body and mass are used interchangeable throughout the specification to describe the main body of system with mass tending to be used for describing embodiments where the body can be both bulky and weighty. However a skilled person should understand that a reference to the mass of the system is also a reference to the main body of the system.

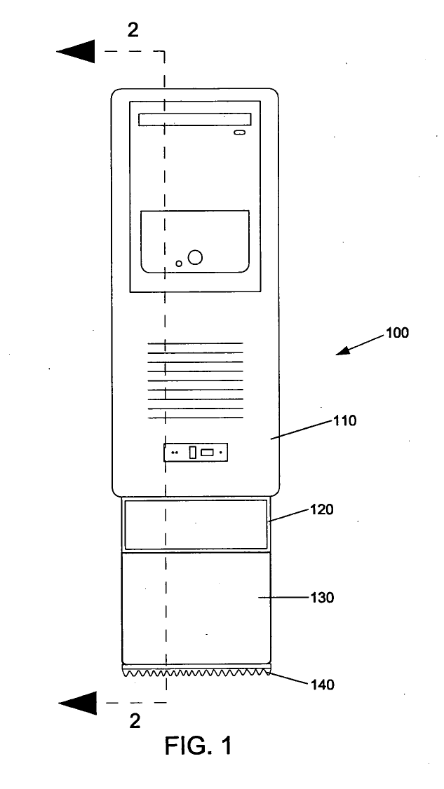

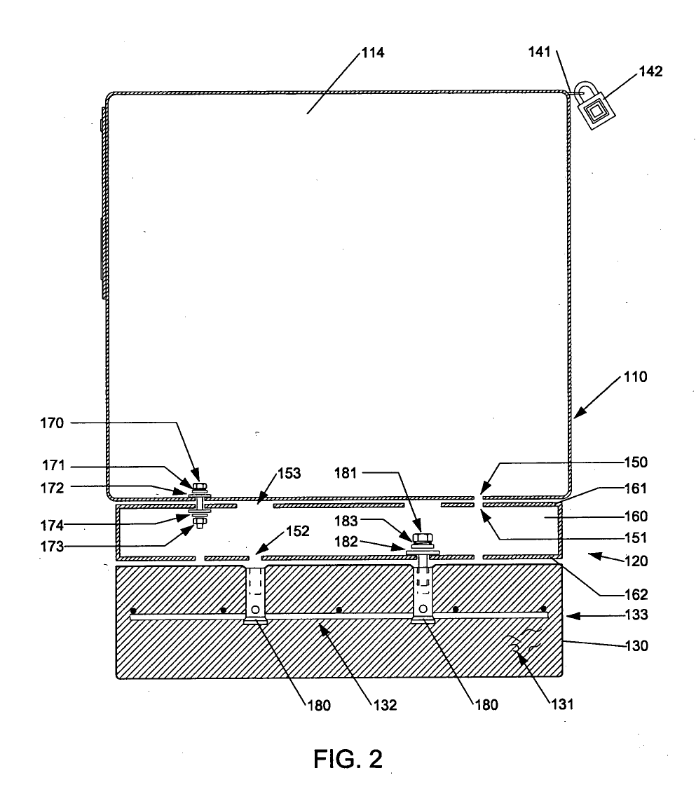

Further specific embodiments of the invention will now be described in greater detail with reference to the accompanying drawings. FIG. 1 shows a front view of an electronic article security system 100. System 100 includes a vertically-positioned PC 110 secured to an intermediary structure 120 located directly below it. The intermediary structure 120 is, in turn, secured to a mass 130, which may be positioned on a piece of upside-down cut carpeting 140, or another similar cushioning material. Cushioning 140 protects the underlying floor from being scratched or impressed by mass 130. A more detailed description of this embodiment is provided in connection with the description of FIG. 2 due to a clearer view from that angle.

FIG. 2 is a side cross-sectional view of system 100. As shown in the figure, a vertically positioned PC 110 fastened to an intermediary structure 120 located directly below it. The intermediary structure is in turn fastened to mass 130. In some embodiments, the intermediary structure 120 may have wall thicknesses of 2-4 mm. Most casings (housings, boxes, shells) for PC open from the side by swinging or removal of a side door leaving opening 114. Holes 150 may be drilled into the PC's base or side casing to accommodate a fastening device. In a preferred embodiment, the holes 150 measure about 6 mm and the fastening device may comprise a 5 mm drive socket screw/bolt.

While it should be appreciated that countless variations are possible, FIG. 1 depicts one of four fasteners 170 (reversibly fastening the intermediary structure to the PC), with four matching diameter lock-washers 171, eight progressively larger washers 172 matched to the diameter of the fasteners 170. The depicted system also includes four hex lock nuts 173, reversibly binding the PC 110 to the intermediary structure 120. Also shown as a cut away are two 10 mm threaded inserts 180, which have been countersunk into mass 130. Threaded inserts 180 are configured to receive two bolts 181, with a similar number of matching diameter lock-washers 183, and four progressively larger washers 182 (matched to the diameter of the threaded insert's counterpart bolt). These fastening structures may be placed in the central part of the intermediary structure if desired to make disassembly more difficult for a thief.

The intermediary structure and body may also, or instead, be attached to one or more other sides of the PC. The side door of a PC may be made lockable by the manufacturer as indicated at location 141 and this locking may be accomplished with a keyed or combination padlock 142 inserted at location 141. Opening the PC's side door usually allows access to one or more other sides for repairs, maintenance, or hardware changes. Opening the side door may allow for access for inserting bolts/screws and washers, or other fasteners, on the inside of the computer (often on the base side).

The location of the components within the PC often varies substantially by manufacturer. Accordingly, the location of the fasteners may similarly vary by brand of computer. Location problems may be overcome by using an easily drillable metal as the intermediary structure and simply placing the drill holes 151 that will capacitate the fasteners 170 in places in the PC where there is tolerance for the screw/bolt head (of 5 mm thickness and 1-2 mm washer thickness, for example). Depending upon the height of the intermediary structure and thickness of the walls of the intermediary structure, the fasteners used to fasten the PC to the intermediary structure may vary widely, such as between 15-20 mm in length.

In some embodiments, the intermediary structure may comprise a hollow tube. In some embodiments, aluminum may be used to form the intermediary structure. For example, aluminum extrusions may be used to form a hollow tube that will suffice for use as an intermediary structure. A variety of different shapes and sizes of intermediary structures may be used and may vary in accordance with the width of the computer base. For example, a 200 mm×50 mm (with a wall thickness of over 3 mm in some preferred embodiments) intermediary structure may suffice in many cases with the exception that a special tool may be necessary to hold nuts in place while tightening in the limited space. It should be understood, however, that smaller (or larger) intermediary structures may be used, such as a 150 mm×50 mm intermediary structure, for example. An intermediary structure with additional security items may need to increase the measurement of its smallest axis.

The intermediary structure may be cut or trimmed by sawing (with a hacksaw or circular-saw or band-saw if the intermediary structure is metal) to approximate the length of the base of the computer. If the intermediary structure is aluminum, it may be easily trimmed with a hacksaw in seconds to tailor it to match an individual PC's base. The PC may also be pre-drilled with the necessary holes prior to shipment.

Usually starting on one of the intermediary structure's sides of greatest surface area, a multiplicity of 15-20 mm large holes 152 (holes preferably 10% larger than the threaded diameter) may be cut, dye stamped, or drilled, preferably on along the middle axis at least 5 cm from any end, with a separation of between 10-20 cm in a uniform distribution. The 15-20 mm holes may be deliberately larger than the head of the anticipated fastener that will be used to fasten the intermediary structure to the mass because most cement fabricators/manufacturers or rock workers cannot place a threaded insert into hardening concrete/cement within a tolerance of less than 2 mm continually.

Having the 15-20 mm hole space may help to overcome tolerance issues and also allows for bimodal insertion of the typical heavy duty (10 mm, for example) plus thread diameter fastener and its bolt head (14 mm diameter, for example) through the 15-20 mm hole.

In some embodiments, the intermediary structure comprises a hollow structure to allow for access to a first wall secured to the electronic article and to a second wall secured to the mass. In addition, the intermediary structure 120 shown in FIG. 2 is elongated with one or more fastening members positioned away from the edge of the opening creating the hollow structure. This provides additional security because, even if a specialized tool were available to access the fastening member(s), the length of the hollow space defined by the intermediary structure and the position of the fastening members may prohibit such a tool from rotating a sufficient amount to allow for unscrewing or otherwise removing the fastening member(s). This is particularly true in the case of a hex nut, which must be back-ratcheted about sixty degrees in order to reach an adjacent side surface of the hex nut to maintain a continuous rotation operation. In a preferred embodiment, the angle between the fastening members and the width of the opening of the intermediary structure does not exceed about sixty degrees.

Although a socket wrench can ratchet with fewer degrees of motion, standard socket wrenches can easily be defeated by placing an obstruction on the opposing internal side of the intermediary structure from the nuts, or an obstruction at the opening of a hollow intermediary structure, such as angle, bar, tube. In one embodiment, such obstructions exceed 1 cm in vertical dimension and may be made of metal. The obstruction(s) may also be secured by rivet or screw, or may be glued or welded into place. With the presence of such a partial obstruction, a socket set will not fit within the vertical confines of the dimension of a preferred embodiment (4.6 cm) to undo nuts because the standard width for a ratchet head at the end of a socket wrench handle is 2 cm and the standard socket is 2 cm and a 1 cm obstruction would not allow enough space for the socket to fit over the nut.

In the embodiment shown in FIG. 2, a hollow space 160 is provided between upper wall 161 and lower wall 162. On upper wall 161, a multiplicity of the largest holes 153 may be drilled/stamped/cut into intermediary structure 120. In some preferred embodiments, holes 153 are 200% (or more) greater in diameter (20-35 mm, for example, in embodiments having 10-12 mm diameter openings 152) than holes 152.

In one embodiment, on the diametrically opposite side of the intermediary structure from the previously drilled large holes, larger holes may be drilled to allow for manual placement (dropping) of the appropriate fasteners into what will be an easily visible, easily accessible, open female threaded insert situated in the mass which will be placed below the upper holes.

To prepare for the unification of the intermediary structure and the PC, several sets of holes 151 (6 mm, for example) may be drilled in the intermediary structure (in preferred implementations within a 2 cm distance of the largest diameter holes on the side with the holes of the largest diameter). This proximity of drilling the small holes allows for manual placement of preferably about 5 mm thread diameter hex head nuts with even larger washers similar to above (to eventually receive the preferably about 5 mm fasteners).

Regardless of the fastener used between the PC and the intermediary structure, the base or bottom of the PC is often malleable or somewhat deformable. It is therefore preferred to strengthen the connection by the use of washers with the fasteners. Thus, in a preferred embodiment, the placement of oversized metal washes (around the fasteners connecting the intermediary structure to the PC) with a washer diameter exceeding (or largest cross measurement of at least 1 cm, most preferably exceeding 1.5-2 cm) is desirable. Single or multiple (progressively larger) washers may also be used to redistribute any possible crowbar/lever forces from the higher force/unit area away from the metal of the PC's base immediately adjacent the holes. It is also preferable that the holes 151 are made on both (opposite) greatest surface area sides of the intermediary structure. This will allow a thin pencil mark or other marker or drill bit or metal object the ability to scratch through both holes to make a mark on the bottom of the PC for proper later drilling there into the inside of the PC.

Preparing the base of the PC to match the pre-made holes of the intermediary structure will now be described. The computer should be shut down and unplugged from any energy source, after which the sliding latch 141 (usually at the top back of the computer) is moved to deploy the side door or expose the PC's components and inner sides.

The intermediary structure may be placed against at least a portion of one side of the PC (most preferably the base). Using the double drilled holes 151 (in a preferred embodiment, of about 6 mm diameter) that are in alignment of the intermediary structure, marks may be made on the base of the PC that will be estimated to result in a drill hole 150 in the bottom of the PC. This will allow for the tool fit, manipulation, and final resting of at least one fastener 170 (possibly plus or minus screw head and several washers)

Once the holes are selected, a scratch or other mark may be made in the outside of the chosen side (usually base) of the PC. The intermediary structure may then be removed and the areas on the inside of the PC may be protected from the metallic debris resulting from drilling into the casing of the PC at the marked areas. Double stick tape, a wad of regular tape, a moist towel, or a small plastic medicine cup rimmed with double stick tape may be attached near the expected entrance site to catch the debris. The hole 150 may be drilled, most preferably with progressively larger drill bits, starting, for example, at 2 mm, 4 mm, and finally 6 mm. Once all holes 150 have been drilled and reamed, the PC 110 may be stood vertically up, thereby allowing the holes to be at the gravitational base. Pressurized gas may also be injected into the computer to clean any potential missed metallic drilling debris and blown out of the PC. In an alternative embodiment the PC may be fixed to the intermediary structure using strong glue or other type of adhesive. In this embodiment drilling in to the PC case can be avoided.

Creation of the mass 130 will now be described. Various sizes of masses may be made. However, a standard size may be configured to match aluminum extrusions that are roughly the width and length of the average computer base. A wood or fiberglass mold may be used to create the mass. In some embodiments, it may be desirable to round or bevel the corners of the mass 130 to make it more difficult for a would-be thief to pick up the structure. If minor or decorative beveling is desired, then silicone may be forced into the corners and edges of a mold for a pleasing appearance. Once the mold is ready, threaded inserts 180 may be placed or suspended in their desired final resting places to match the large holes 152 on the intermediary structure. Cement or concrete may be placed into the mold. In some embodiments, the cement, concrete, or other liquid hardening material may be enhanced or strengthened by placing fibers 131 into the mix, including but not limited to polyethylene, polyester, polypropylene, and/or fiberglass. The concrete may also be strengthened by placing metal, preferably steel, reinforcing wire 132, usually cut from a grid or woven mat and placing it preferably in a middle or lower level of the mass 130. It may be helpful to use a threaded insert having a pre-formed base hole—for example, a smaller (smaller than the internal thread diameter) base hole in a 10 mm internal thread diameter/16 mm external diameter threaded insert or in a 12 mm internal thread diameter/18 mm external diameter threaded insert, excluding base extrusions—through which part of the reinforcing steel may be passed so as to further enhance strength. Alternatively, such holes may be placed in threaded inserts lacking a pre-formed base hole.

In a preferred embodiment, the number of threaded inserts 180 placed in the face of the cement to abut the intermediary structure 130 is at least one and should match the proper intermediary structure predrilled holes and visa-versa. Placement of the threaded inserts may be such that when the concrete has hardened properly their final resting place is countersunk below the level of the surrounding concrete, such as by about 1-2 mm.

Unfortunately, the usual tolerance (difference between desired dimension or placement and final product) for threaded insert placement into concrete under standard conditions is about 2-3 mm. In other words, the final product insert may be off by 2-3 mm. It is noteworthy that the tolerance or error numbers may be additive between fixtures.

This is one of the benefits of having the intermediary structure system. The intermediary structure helps bring/refine the exactitude of a PC down to the crude heaviness of stone or stone-like materials. Threaded inserts in the stone or stone-like materials or minerals making up the mass preferably number at least two to prevent rotation and theft.

It may also be desirable to place one or more threaded inserts in the back lower outer locations 133 of the mass (at least 2 cm from any edge to maintain strength). The purpose of these threaded inserts, which may somewhat resemble the tail-lights of a car, is to receive by screwing motion eye-bolts (bolts with a closed circle at the outer terminus). Eyebolt placement allows padlock(s) to join one or more PC/mass units together, which makes theft even more difficult.

If the threaded insert is misplaced or a new threaded insert desirable in another location, or if it is desired not to associate the threaded insert with the mold or hardening concrete, then the threaded inserts may be epoxied or glued into place. A preferred implementation of this process is as follows. A masonry drill bit is chosen that is slightly larger in both width and depth than the insert to be placed. The hole is drilled in sufficiently hardened concrete to match the planned intermediary structure holed as mentioned previously. Epoxy made for building fasteners is injected into the drilled hole. If the threaded insert also has a hole at its base, then it is beneficial to place epoxy there too prior to pushing the threaded insert into the epoxy-containing drilled hole. The hole should be drilled deep enough to allow the threaded insert to fit comfortably and bond in a position that is preferably slightly counter-sunk, such as by 1-2 mm, for example.

After having prepared the aforementioned items, some techniques may be used to facilitate the final attachment process. On the side of the intermediary structure intended to abut the PC, epoxy or glue (preferably superglue (cyanoacrylate)) may be lightly dabbed onto the nut 173 and several progressively larger washers 174 so that they resist gravity and sit upside down in place and more easily receive the bolt coming from within the PC. The largest holes 153 already drilled into the intermediary structure 120 permit easy manual access to glue the nut 173 and washers 174 to the “roof” of the intermediary structure 120. Temporary use of one of the fasteners (that will be used to finally attach the PC to the intermediary structure) as a guide may be useful.

The guide may remain in place temporarily until the superglue has bound the nut 173 and progressively larger washers 174 temporarily into place. A handheld tool for tightening or un-tightening may be made from a common wrench set where in the distal end matches the shape of the nut (preferably thin and hex) but limits its ability to fall through the receiving end of the wrench by slight obstructions. This slightly modified distal end of a wrench may be cut and welded to a length of metal to become the shaft and handle to a length sufficient to allow the distal tip to sit under the most far reaching nut and restrict its motion while the fastener from within the PC is screwed into the nut. It would be exceedingly rare for such a would-be thief to carry such a specialized tool. Button head hexagon drive socket screws are a preferred screw design and shape for the screws/bolts of used in various embodiments disclosed herein. Other preferred screw/bolt types include cylinder head, hex head, pan head, and flat head screws. Many of these preferred screw/bolt types may be used to make wrenches virtually useless in separating the components of the security system. Again, it is also possible that the bolts placed within the PC can have security heads (such as shown in FIG. 7) so as to make it even more improbable for a would-be thief to be carrying the proper tooling for fast detachment. Security nut shapes are possible as well to fit another specialized tightening or un-tightening tool.

Once the attached nuts' and progressively larger washers' glue has dried, the intermediary structure may be oriented over the matching sites for the mass threaded insert attachments. An option exists prior to seating the intermediary structure over the mass to completely seal the edge tolerances of the junctions between the concrete and the intermediary structure. This option involves placing plastic, preferably the long axis of a “T” cross-sectional shape of plastic (measuring less than 7 mm in any dimension, for example) into the potential gap between the intermediary structure and the mass. Preferably 10 mm diameter threaded fasteners 181 are slid through one or two lock-washers 183, followed by one or more of the progressively larger washers 182, and then placed through the large median manipulation holes 153 of the intermediary structure and through the opposing median intermediary structure holes and into the threaded inserts 180 in the mass 130.

A matching shape of “socket/key/driver” to the shape of the recipient location in the fasteners may be used to tighten the fasteners into the countersunk threaded inserts 180 located in the mass. Once the intermediary structure 180 is fastened firmly to the mass 130, the PC 110 may be replaced upon the matching holes in the intermediary structure 120.

The fasteners (with hex or security shape head key shapes, if desired) are then inserted through lock-washers 171, and progressively larger washers 172 (preferably between 1-2 cm) and then passed through the holes 150 in the base of the PC and screwed into alignment in the recipient acrylate glued nuts 173, lock-washers, and progressively larger washers 174 in the intermediary structure. The previously described embodiment thus demonstrates a system wherein access is impeded to the fastening hardware between the intermediary structure and the mass and between the electronic article and the intermediary structure. Of course, other embodiments are contemplated in which access to less than all of the fastening hardware, such as at least one fastening member, is impeded by the system. Moreover, in other embodiments, access to only the fastening hardware between the intermediary structure and the mass may be impeded, or access to only the fastening hardware between the electronic article and the intermediary structure may be impeded.

Furthermore, additional deterrence to internal access of the electronic article may be provided (for example, by an external door padlock or trailer lock). And, when selectively positioned, next to a corner or edge, for example, the size and/or shape of the mass of the system may prohibit rotation of the device about an axis which passes through or close to an external threaded insert sufficiently to release either of the bolts or screws or threaded inserts to allow disconnection or theft.

As the fasteners are tightened, the acrylate glue will often break loose and the unit will spin and fail to secure. It is as this point that the specialized extended about 5 mm nut receiving wrench may be placed into the intermediary structure just under the nut 173 of the unit to be tightened. Whatever computer hardware is in the way of the tightening keys or screwdrivers or shaped keys is temporarily removed until all fasteners have been placed and tightened sufficiently. The hardware and the side door of the PC may then be replaced, thereby closing the side opening 140, and lock 142 may also be replaced. Energy and leads may then be reconnected to the PC. The bound unit is now ready to be placed atop a protective surface such as inverted carpet against flooring or tile, wood or concrete.

The space that is the remainder of the intermediary structure may be utilized for security. For example, one or more components may be placed within the intermediary structure and/or remaining dead space in the PC such as sensors (motion, magnetic, electronic, wired or wireless), detectors (GPS, smoke or heat), alarms (sounding or silent), lights (decorative or warning such as strobe, flashing or colored), gas/vapor/aerosol emitters (such as fire retardant, noxious smell (such as butyric acid), toxic emitters (including nerve gas, mace, pepper-capsaiciniods, such as capsaicin, and smoke). The intermediary structure may also house other defensive or offensive measures or countermeasures which may include smoke bombs, stink bombs, traps/clamps (mouse, rat), rasps, barbs, etc. The intermediary structure may also include a battery, alarm, flashing light, smell, fixed, or moveable sharp teeth or points, GPS, electromagnetic spectral sensor, electrical capacitor for electric shock, fire extinguisher, physical storage, hiding place, finger print surface retainer, perpetrator marking paint, speaker (stating such phrases as “Help, Police, I'm being stolen” or “Stop thief”). Still other security measures that may be provided with the system include flares, fireworks, incendiary devices, fuses, heating elements, electronic ignitions, cameras, paint (able to drip to leave trail and/or airborne distributable to mark the perpetrator), odoriferous compounds (for example, butyric acid), and/or a bell clapper (could strike the intermediary structure and make it act like a bell thus attracting attention).

In one illustrative embodiment, a speaker connected to a motion sensor may be connected with an integrated circuit controlling alarm pattern sounds powered by a battery. If the bound unit of PC/intermediary structure/mass were to be picked up, one of the areas likely to be gripped in the inner upper top portion of the intermediary structure. This may be discouraged by affixing angle shaped metal with sharpened teeth or projections capable of causing discomfort then grasped made from one side of the angle. The other side of the angle may be epoxied or acrylate glued to the upper inner top portions of the intermediary structure so that the teeth reside where a would-be-thief's grip is likely to be placed when absconding with the unit.

Alternatively, tubes can replace angled extrusions by pressing the circular tubes in vices or presses until sufficiently flattened. Tubes can maintain their shape and replace extrusions if used in a multiplicity however, outer tubes should align with the edges of the mass to prevent lever (crowbar) application and be attached firmly to centrally located tubes, which may be used to allow the hardware connection between the PC and the mass.

In another illustrative embodiment, computer hardware and/or software may be used to control any combination of the materials/countermeasures mentioned above to function in concert. Furthermore, the aforementioned security/countermeasures may be secured in the available space in many ways. For example, with respect to the embodiment of FIGS. 1 and 2, an added security component may be secured to main bolt 181. Alternatively, a security components may be added by placing the component(s) in a mesh of dense plastic and attaching the mesh by a standard (in the field of electricity) conduit clip. The hole in the conduit clip may be included in the passage of main bolt 181 just below lock-washer 183 should the customer choose to purchase various extra security components/countermeasures.

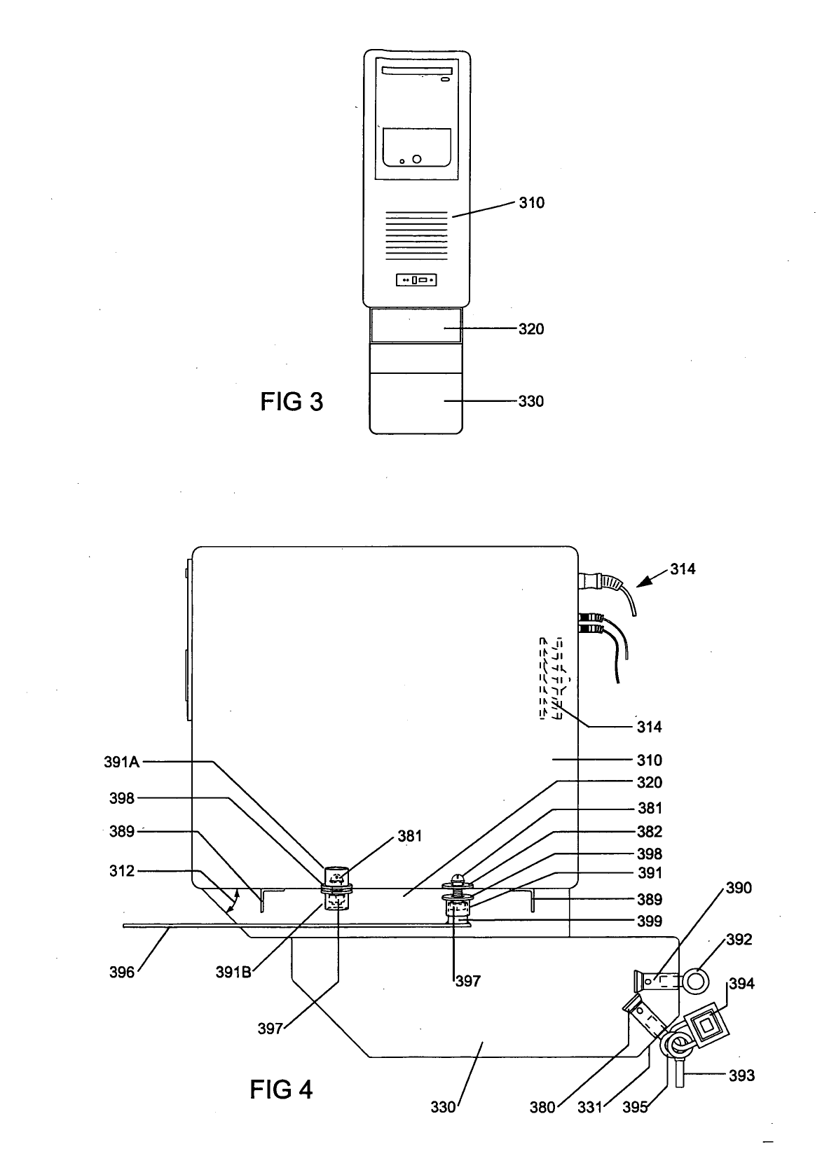

FIGS. 3 and 4 illustrate an alternative embodiment. As shown in these figures, a vertically-positioned PC 310 is moved partially forward along with a portion of the intermediary structure, thereby causing the bound unit of PC and intermediary structure 320 to override and overhang the mass 330. This formation is intended to give the illusion of a “floating PC” and may also provide some footspace under the front of the PC.

FIG. 4 depicts a side view of a vertically positioned PC 310 and intermediary structure 320 bound unit fastened in a fashion to overhang over the mass 330 to give the illusion of a “floating PC” because of eyesight viewing angle 312. As can be seen from this figure, the electronic article 310 is secured to the intermediary structure 320 such that the electronic article 310 extends substantially beyond an end of the intermediary structure 320 and substantially beyond an end of the mass 330. Note computer power plugs 311 and cords and information transfer plugs and cords usually require 6-10 cm clearance from a wall anyway because of rigidity of these cords. Therefore, moving the mass back does not result in a loss of space or distance from a wall. Fan 314 also requires airspace for airflow. Care must be maintained to consider the center of gravity so the PC does not fall forward if one were to attempt a mass of smaller weight and dimensions or lighter concrete (aerated for example).

In an alternative embodiment, the hardware (bolts and nuts) fastening the PC 310 and intermediary structure 320 may enhance tamper resistance by use of a tube-washer-complex. The tube-washer-complex may be comprised of a tube 391, one or more larger washers 398 and one or more smaller washers. The tube may be located adjacent to or bonded to one or more large washers. If metal, the tube may be welded to a large washer, preferably of outer diameter equal to or greater than the outer diameter of the tube, and of inner diameter capable of receiving bolt 381 (preferably exceeding 5 mm diameter threads). Welding a metal washer to the tube can reduce the ability of a tool to deform the washer and may enhance the washer's ability to resist tampering from prying instruments such as a chisels. Tube-washer-complexes applied to both the top 391A and bottom 391B ends of a particular hardware grouping can offer additional resistance to tampering once contained bolt 381 is sufficiently screw-tightened into its opposing lock nut.

A tube selected for a tube-washer complex, is preferably comprised of a metal such as steel, and has an internal diameter exceeding the external diameter of a socket-wrench-probe and a height less than the height of the socket portion of a socket wrench, excluding the handle and shaft. The socket-wrench-probe may be constructed of metal shaft 396 fastened, bonded or welded to the base of socket portion 397 of a socket wrench. It may be beneficial if the outer diameter of the socket or external washers in the socket-wrench probe would still allow passage past impediments/obstructions 389 placed in the intermediary structure 320. Impediments/obstructions 389 are preferably right angle or ‘U’ shaped metal such as aluminum or steel exceeding 2 mm thickness and may be rivet fastened to the inner, upper portion of the intermediary structure (preferably an aluminum extrusion). The socket end portion 397 of the socket-wrench-probe may need to be rotated axially to bypass the impediments/obstructions 389.

The shaft of the socket-wrench-probe preferably exceeds the length of the intermediary structure 320 and preferably less than 3 mm thick or 12 mm wide; the socket portion 397 welded to the shaft is preferably less than 15 mm diameter. The socket-wrench-probe and tube-washer-complex are preferably used as follows: the tube-washer-complex is loaded with a small washer (preferably metal with a hole large enough to allow passage of bolt 381) of outer diameter less than the internal diameter of the tube, followed by a small reduced-friction washer (preferably comprised of polytetrafluroethylene) or lubricated ball bearings, followed by a small washer (preferably metal with a hole large enough to allow passage of bolt 381). The socket-wrench-probe is loaded with a lock washer 397 (preferably metal with a friction ring of polyamide) capable of receiving bolt 381. The loaded socket-wrench-probe is then fit into the loaded tube-washer-complex and the probe and complex are passed through the intermediary structure until the large washer 398 hole is aligned with bolt 381. The portion of the probe handle lying outside the intermediary structure may be forced in such a fashion to bring rotating bolt 381 through washer 398 and the other contained aligned washers into locknut 397. The purpose of the reduced friction is that a locknut cannot be undone unless some friction or force can be exerted upon it while an attached bolt is in motion; thus a prying device acting upon the junction washer 398 and intermediary structure 320 would eventually have reduced forces applied upon locknut 397 after more than a few turns, additionally, tube 391 surrounding locknut 397 would be difficult to collapse against the locknut by pliers or other means because of limited space within the intermediary structure.

In one embodiment, as also shown in FIG. 4, the system may have at least one threaded insert 390 placed and hardened into the rear of the mass at a lower edge of a shorter vertical side end of the mass 330. Alternatively, threaded inserts may be placed in other surfaces of the mass, preferably the lower regions of the mass. In some embodiments, these inserts may be positioned such that they are sufficiently spaced from the edges of the mass to resist removal by hammer chipping. The threaded inserts may have a size of 10 mm for the threaded inner, and may have an outer dimension 16 mm, and may have a depth of 35 mm depth. Alternatively, the threaded inserts may have an inner dimension of 12 mm, a depth, of 50 mm, and an outer dimension of 18 mm). An appropriately sized eyebolt 392 may be screwed into the matching sized threaded insert. The base of system may have a plurality of bevels which can enable the user to alter the placement, accessibility of threaded inserts and thus possible theft resistance. A bevel 331 at the rear of the base may contain the orifice of a threaded insert 380 into which may be screwed eyebolt 395. The location and orientation of such an eyebolt may facilitate locking with a floor eyebolt. Increasing the bottom bevels of the base, forward and especially aft/back increases the difficulty to pick up and carry off the unit, and may aid in hiding or sequesters the eyebolt/threaded inserts or wood screws thus increasing the level of difficulty of tampering by saw or bolt-cutters.

The floor, or other surface such as a wall or cabinet, may also have an eyebolt 393 fixedly attached thereto. Eyebolt 393 may be screwed through the hole in the floor or placed into a threaded insert in the floor. The eyebolt 392 or 395 in one of the threaded insert of the mass 330 may then be padlocked 394 into the eyebolt or eyescrew 393 of the floor. Thus, the mass is coupled to an external fixture to inhibit removal. Installing the system within around one-half of the length of the base plus electronic article form a wall, corner or large immovable object prevents a potential thief from being able to move or rotate the system sufficiently to unscrew any of the eyebolts from the threaded inserts. Installing the system in close proximity to walls, corners or large immovable objects can also serve to inhibit access to the coupling mechanism, for example to make sawing through any coupling members or compromising any locks difficult, due to the bulk of the system and the proximity of immovable obstructions. The distance from the wall or other obstacles required to inhibit access to the eyebolts or inhibit rotation of the mass and article in combination can be tested using a “spin test” to determine a suitable position to secure the mass. It may be determined that this distance from the wall or other obstacle may be more or less than one half the base length of the mass depending on the geometry of the space in which the electronic article is being secured.

An eyebolt or eyescrew can be applied to the floor or wall or large immovable object which can, in turn, be locked or fastened to the eyebolts on the mass. Many types of locks may be used, including padlocks and discus-locks. Although an example has been given using eyebolts as coupling members attached to the mass and the floor, other types of coupling are envisaged. For example, drop-in anchor, hammer drive anchor or Dynabolts may be used to secure fittings in concrete floors. A person skilled in the art should appreciate that any suitable type of coupling mechanism may be employed and all such alternatives presently known and to be developed in the future are envisaged.

One or more threaded inserts may be placed in the mass to match the uniform distribution distance of the holes in the intermediary structure. In this way, the PC/intermediary structure combination may be “marched” forward to override the mass by a variety of uniform multiples of distance (that distance being the distance between the center of each intermediary structure hole which should match or equal the distance between the uniformly spaced threaded inserts in the mass). Again, placement of the threaded inserts may be such that when the concrete has hardened properly their final resting place is countersunk below the level of the surrounding concrete by about 1-2 mm and a short distance (preferably at least 2 cm) from any edge to maintain strength. If the threaded insert is improperly placed or a new threaded insert desirable in another location, or if it is desired not to associate the threaded insert with the mold or hardening concrete then the threaded inserts may be epoxied or glued into place as previously described.

The preferred embodiment of this design is created similarly to the embodiment of FIGS. 1 and 2 with the following enhancements. On the intermediary structure's side of greatest surface area, at least one 15-20 mm hole (holes preferably at least 10% larger than the threaded diameter) are cut, dye stamped or drilled, preferably on along the middle axis and a matching separation distance (between 5-20 cm, for example) in a uniform distribution.

One or more threaded inserts may be placed in the mass to match the uniform distribution distance of the holes in the intermediary structure. In this way, the PC/intermediary structure combination may be “marched” forward to override the mass by a variety of uniform multiples of distance (that distance being the distance between the center of each intermediary structure hole which should match or equal the distance between the uniformly spaced threaded inserts in the mass). Again, placement of the threaded inserts may be such that when the concrete has hardened properly their final resting place is countersunk below the level of the surrounding concrete by about 1-2 mm and a short distance (preferably at least 2 cm) from any edge to maintain strength. If the threaded insert is improperly placed or a new threaded insert desirable in another location, or if it is desired not to associate the threaded insert with the mold or hardening concrete then the threaded inserts may be epoxied or glued into place as previously described.

It is also possible to fasten a PC or another electronic article directly to a mass. For example, once the concrete or another hardenable liquid has hardened with the threaded insert/fasteners in place, the PC may be placed directly over the openings of the threaded inserts in the mass. A marking object may be placed into the insert to scratch the desired drill-hole selection into the bottom of the PC, or a paper transfer template may be made to transfer the desired drill information to the bottom of the PC. Then, the bottom of the PC, with holes drilled, may be placed over the concrete block containing the recipient threaded inserts. Non-standard (security shaped heads, see FIG. 7) may be used to provide another layer of security. Using steel concrete screws is a possible alternative.

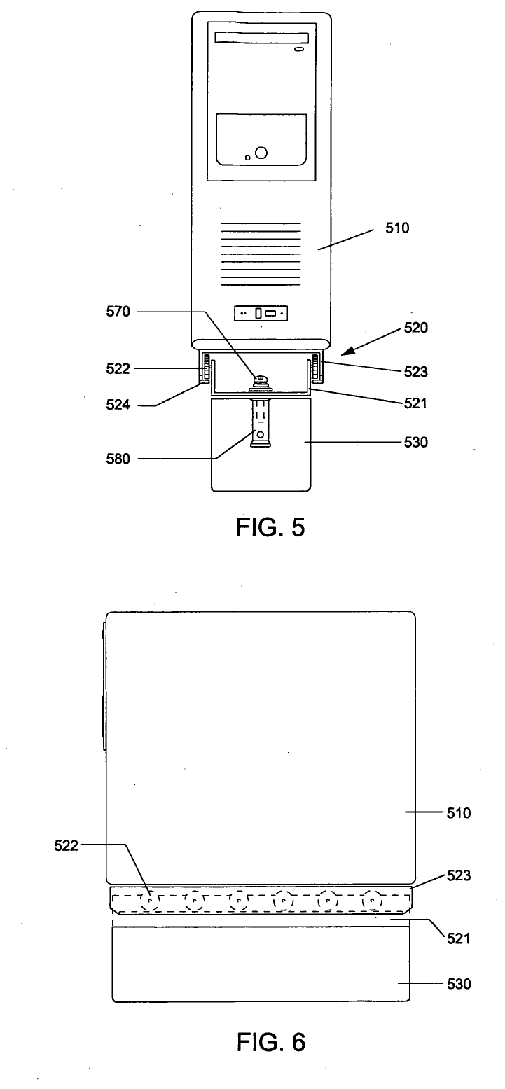

FIG. 5 depicts still another embodiment. The intermediary structure 520 in this embodiment is configured to allow the electronic article 510 to be moved relative to the mass 530. More particularly, the intermediary structure 520 includes a means for allowing the electronic article 510 to slide relative to the mass 530.

The sliding intermediary structure may be divided into a superior half 523 and an inferior half 521. Note the vertically positioned PC 510 fastened on an intermediary structure comprised of sliding halves (inferior half 521, wheels 522, and superior half 523 and superior half extension/encasement 524). The inferior half is fastened to threaded inserts 580 in the mass 530 by fasteners, such as button head hexagon drive socket screw/bolts 570 and locknuts and progressively larger washers or other fasteners, recipients and counterparts. The preferred shape to the inferior half is a ‘U’ (of similar dimensions and characteristics to the lower portion of the previously described rectangular cross section aluminum extrusions) and may contain outwardly placed and superiorly protruding wheels, or bearings (in a channel). The preferred shape of the superior half of the sliding unit is an inverted ‘U’ that is appropriately wider than and extends over the inferior half's wheels (or bearings as the case may be) and also is formed/bent to capture and restrict motion about the lowermost aspects of the wheels.

The remainder of the assembly and attachments to the PC and mass of the sliding device are similar to the embodiment of FIG. 2 regarding attachments and fasteners. This is because the central and axial aspects of the superior and inferior halves are designed to be similar to maintain uniformity in their drill hole and fixation sites.

FIG. 6 shows a side view of the embodiment of FIG. 5. This formation may be locked in place by such methods as an eye loop bolt and padlock and give a more variable illusion of a ‘floating PC’ which provides footspace under the front of the PC.

FIG. 7 illustrates some examples of non-standard Drive Socket Screw/bolt shaped heads for added security. The hole in the top of the bolt may also be filled with a substance that may be reversibly removed so as to make theft by defeating or breaking the casing lock and unscrewing the screw/bolt heads and even more difficult. Such substances may include acrylate glues, epoxies, waxes, and plastics or shaped plugs.

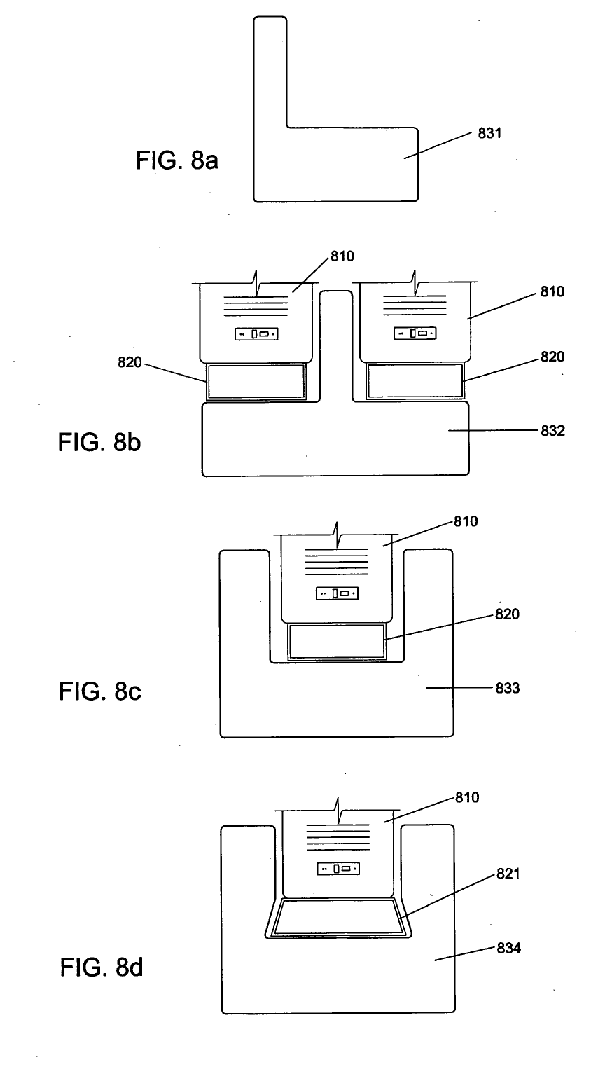

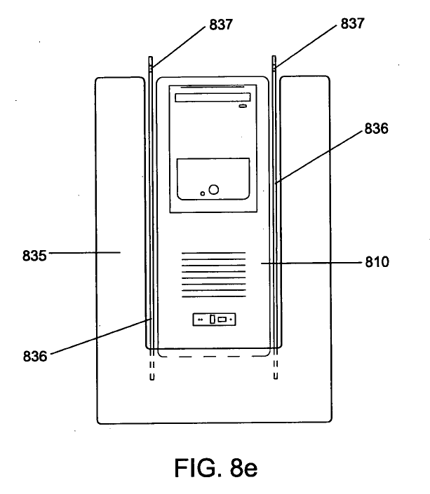

FIG. 8 illustrates views of the frontal cross section of a mass of various other preferred embodiments. In FIG. 8A, note the L-shaped mass 831 that may be shaped in and/or attached to concrete. Note further that this embodiment may, but need not, placed extend all the way to the top of a PC and/or completely to the posterior.

In FIG. 8B, note the inverted ‘T’ shape, wherein the mass 832 is shaped to accommodate at least two PCs 810 and/or intermediary structures 820.

In FIG. 8C, note the partial ‘U’ shaped mass 833, wherein a recessed region is formed in the mass to accommodate the PC 810 and/or intermediary structure 820. This design lowers the center of gravity for the PC. It also allows a lower height to the overall unit for use under desks of limited size or height.

In FIG. 8D, note the inwardly formed partial ‘U’ shaped mass 834, wherein a groove is formed in the mass to accommodate a trapezoidal (possibly sliding or advancing, with restriction) version of an intermediary structure 821.

In FIG. 8E, note the completely encasing shaped mass 835 with a large groove (that preferably does not extend through either the front or the back end of the concrete) is formed therein. Also shown are laterally placed steel (8 mm×40 mm, for example) steel straps 836 with drilled holes 837 (17 mm, for example). The steel straps are sunk deep in the mass 835. Restraint may be made in this embodiment by standard hardware, cables, and locks placed across holes 837.

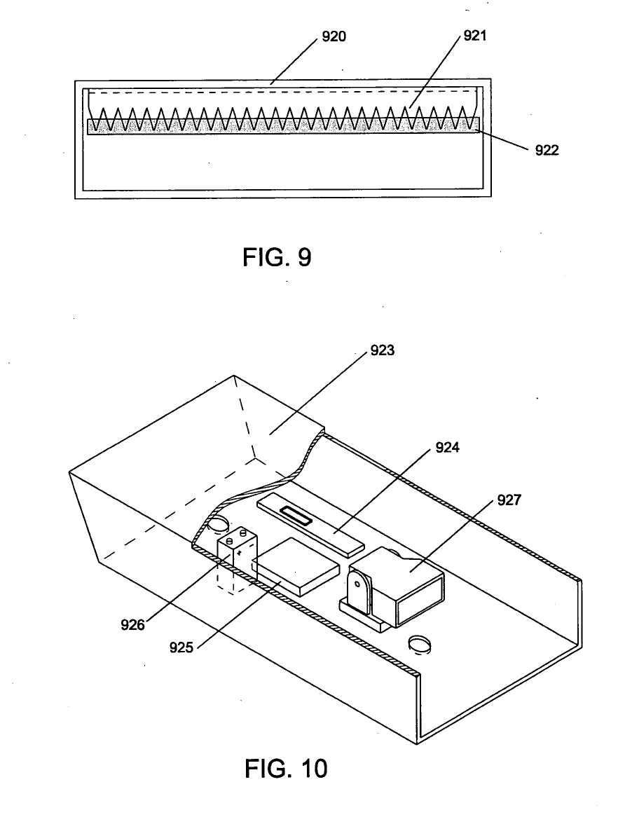

FIGS. 9 and 10 depict alternative embodiments having various internal modifications to be preferably used in connection with the intermediary structure. The embodiment of FIG. 9 includes metal teeth 921 and plastic teeth cover 922. Cover 922 comprises an upper surface that matches teeth 921 to cover teeth 921 when the owner needs to briefly lift on the area 921.

The ends of the intermediary structure may be modified to make it difficult for a would-be-thief to lift up the composite PC, intermediary structure, mass unit. As it is natural for said thief to lift the unit at the intermediary structure top end areas, these locations may be modified by epoxying, or riveting in angle shaped metal such as aluminum wherein one angle limb has been formed into sharp projections or teeth 921. These teeth may also be made from a metal hinge which is left in the down position and occludes much of the opening of the intermediary structure. When a hand is inserted in the end of the intermediary structure, the hand pushes in the hinged teeth and pulling the hand back out pulls the teeth out but occludes the passage thus catching the hand of the perpetrator in the intermediary structure's hinged teeth.

FIG. 10 illustrates other modifications for intermediary structure 923, including a motion sensor 924, central processing unit 925, battery 926, and siren/speaker 927 preferably at least 110 dB. These devices may be located towards the center of the intermediary structure to thwart unwanted disabling.

Upon detecting that the PC has been moved, the motion sensor may trigger the CPU to send a signal to the alarm unit to emit a loud sound that will continue while the perpetrator runs carrying what may be a heavy object (that may even be painted with fluorescent paint ‘stolen’ on the bottom of the mass). The intermediary structure may also contain a cellphone, antenna, or another transmitter, receiver, or transceiver that may send and/or receive information or communications over the electromagnetic spectrum.

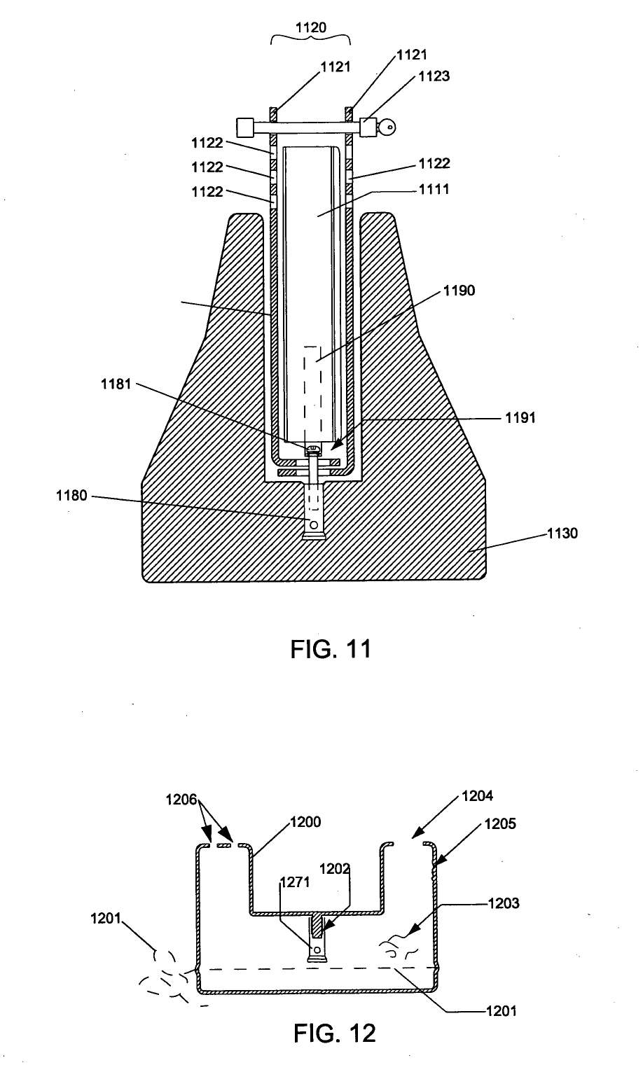

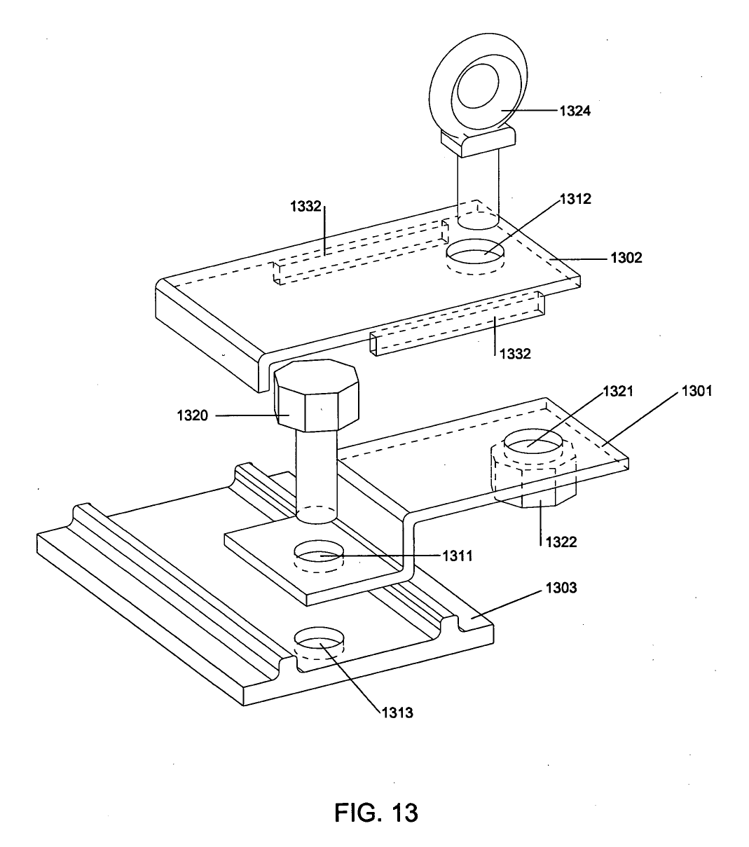

FIG. 11 depicts yet another embodiment that is particularly desirable for use in connection with securing laptop computers. The system includes a vertically positioned laptop-PC 1111 releaseably encased in a in a metallic or plastic cage 1120, which is fastened directly to a body 1130 by fastener 1181 (bolt in a preferred embodiment) into fasteners 1180 (threaded inserts in a preferred embodiment). In a preferred embodiment, threaded inserts 1180 may be positioned such that they are inaccessible in the presence of a space-occupying laptop 1111.

The “cage” in this embodiment may be comprised of two or more steel 8 mm×40 mm cross-sectional-dimensional “side” restraints 1121 which may be predrilled at the top end to accept and lock in the laptop-PC. The bottoms of the side restraints may also be predrilled to allow for fixed or adjustable attachment to the body's recipient threaded insert 1180. The term “side” here is used to indicate the side of the cage 1120 and body 1130 as a composite security unit and these “sides” actually only contact the top and bottom of a laptop (as one refers to a laptop in its traditional position of sitting closed laying flat on a desk). The side (really laptop-top and laptop-bottom) restraints 1121 in this embodiment are bent in mirror images in the shape of an “L” so that the bases of the L may interlock or slide over one another to achieve a desirable ‘grip’ to the apparent sides (top and bottom). Pre-drilling superiorly may be done in a plurality of holes 1122 (17 mm, for example) to accept a lock 1123, such as a standard trailer lock, and accommodate varying laptop sizes. Pre-drilling at the bottom may be done as a slot or hole (13 mm, for example) to accept an appropriate fastener.

If the siderails are comprised of metals offering greater saw resistance, for example hardened steel, alloy steel and spring steel, then the ability to adjust the distance between side-rails and laptop is less problematic. Fixed side-rails may be custom made to fit an individual computer or delivered as a standard size. A preferred embodiment of fixed side-rails may be comprised of one or more pieces. Such fixed side-rails may be manufactured relatively easily by welding a common (ordinary) steel ‘U’-shaped bottom to 2 spring steel side-rails. Preferably, the lower central ‘U’ shaped portion contains a hole through which a bolt may bind the fixed side-rail unit to a threaded insert in the laptop model base. A cylinder shaped lock such as a trailer lock may be passed through opposing holes in the upper side-rails to restrain the laptop.

A thinner and smaller (5 mm×20 mm, for example) cross-sectional steel L-shaped slide bar 1190 may be predrilled with one or more holes. An optional slide bar may be used to prevent movement of the laptop within the mass in its longitudinal axis by restraining the rotation or movement of the laptop about its smallest axis. The slide bar 1190 may be variably positioned when tightened into the threaded insert along with the side restraints or may be releaseably fastened at another location on the mass or the “side” restraints.

In an alternative embodiment, the side restraints may be collapsible such that they may be selectively extended above the mass. In other words, each of the side restraints may be configured to extend above the mass and then be selectively collapsed within, next to, or at a lower height above, the mass. For example, the collapsible side restraints may each comprise a plurality of telescoping side restraint members such that the telescoping side restraint members may be collapsed by telescoping the members together and thereby withdrawing the side restraints within the mass. Alternatively, a hinge and/or latch system may be used to selectively collapse and extend the side restraints.

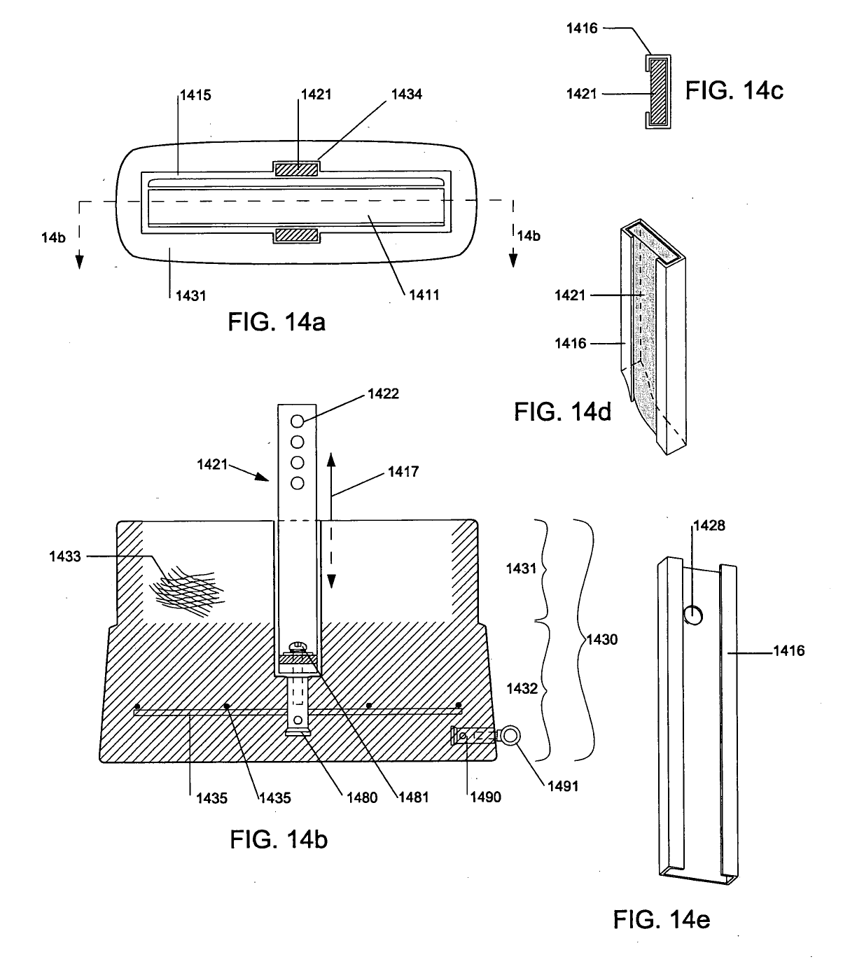

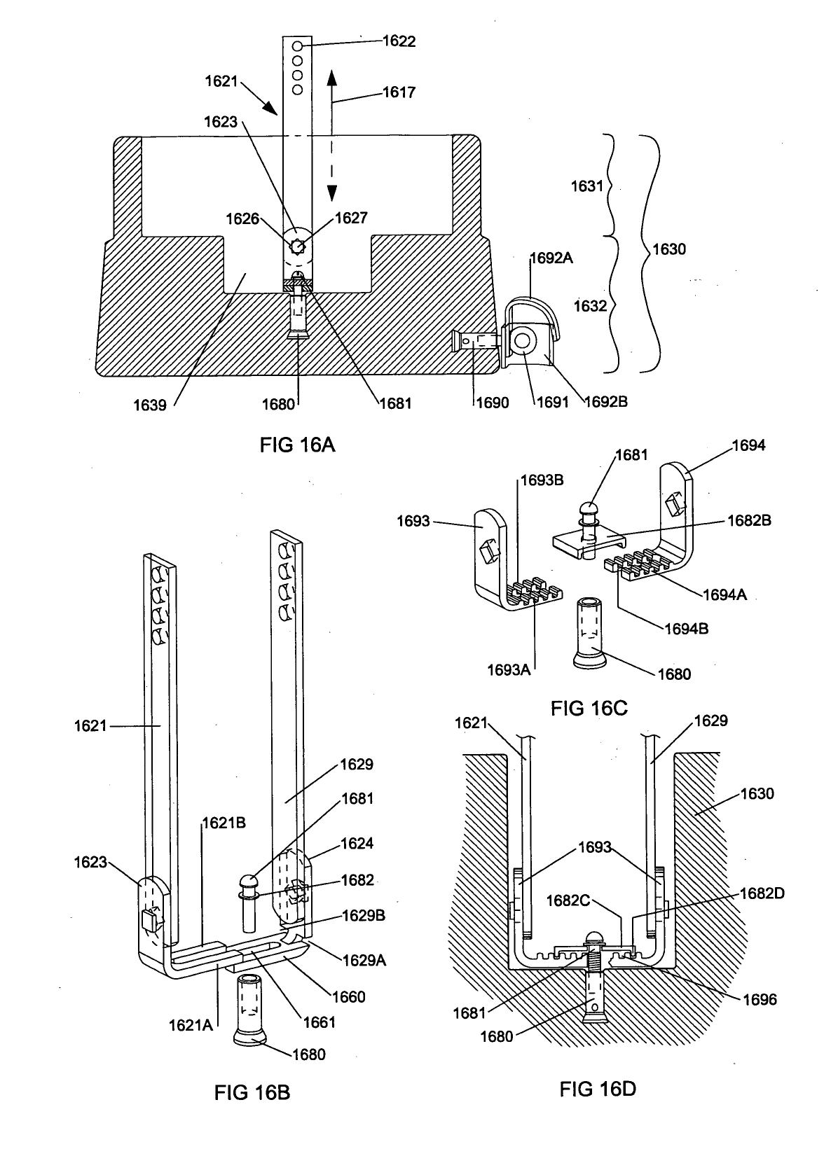

Alternatively the side restraints may be formed using two or more interlocking portions adapted to be manually engaged and disengaged, wherein in the presence of the space occupying laptop the interlocking portions cannot be disengaged. For example, as illustrated in FIGS. 16A-D the side restraints may comprise first L shaped portions 1623, 1624, adapted to be attached to the body as described above. The L shaped portions 1623, 1624 may reside entirely within the cavity of the body, and be connectable to further side restraint portions 1621, 1629 to extend the side restraints external to the cavity to accommodate a laptop. In an embodiment the L shaped portions 1623, 1624 can be engaged with the further side portions 1621, 1629 using an interference-fit locking mechanism. For example, one portion of the side restraint 1623 can have a projection having a locking head 1627, for example having a rectangular shape, adapted to be passed through one or one or more cooperatively shaped apertures 1626 in another portion of the side restraint 1621 when the two portions are rotated relative to each other. For example, the head 1627 and aperture 1626 may only match to enable the head 1627 to pass through the aperture 1626 at 90° relative rotation. Once the two portions of the side restraints 1621, 1623 are aligned, interference between the head 1627 and the surface of the side restrain 1621 adjacent the aperture prevents the two portions 1621, 1623 being separated. Presence of the laptop prevents the two portions 1621, 1623 of the side restraint from being disengaged by limiting movement. Further limitation of relative movement can be caused by protective sleeves, as illustrated in FIGS. 14c, 14d & 14e, placed about the area where the portions of the side restraints are joined. It should be appreciated that each side restraint may comprise more than one portion. Use of more than two portions may enable the length of the side restraints to be adjusted to accommodate different sized laptops. For example, one or more portions may be omitted depending on the size of the laptop, or a set of different length side rail portions may be provided for use with different laptop sizes. Further, more than one cooperatively shaped aperture may be provided to also enable adjustment of the side restraint length.

Access to the binding mechanism 1191 between the laptop-PC cage may be provided only once the standard lock or trailer-hitch lock 1123 connecting two or more portions of the cage sitting atop the laptop has been unlocked and the laptop removed. The base and/or sides of the cage may have one or more predrilled holes allowing releasable attachment via, in this embodiment, a screw/bolt into a female threaded insert 1180, or inserts, which may be placed into hardening concrete, for example. To reduce the ability of a saw to attack the cage, in one of the few regions where sawing may damage the contained PC the least, that being near the junction of lock 1123 and holes 1122 of “side” restraint 1121, hardened alloy inserts may be adjustably or fixedly attached; the hardened alloy inserts may bear holes or portions of holes, and may be shaped to block perpetrator tool access or shift to thwart efficient tool movement or may be formed to partly cover portions of “side” restraints by slide-able, clip-able or other means; inserts with boron are a preferred hardened alloy insert, other preferred inserts may contain chromium, manganese, vanadium, carbon, tungsten, or titanium. A tight fit between laptop 1111 and lock 1123 may be improved by placing a length of space occupying material above fastener 1181 and along the inside bottom, or hollow, of mass 1130 where the laptop rests. Adding such space occupying material may provide cushioning as well as force the laptop directly superiorly into the horizontal section of the lock between “side” restraints 1122. For use with an alternative embodiment, such space occupying material may be soft and may include but not be limited to plastic, rubber, foam, carpet, cotton fabric, synthetic fabric and wood. It may also be beneficial to minimize space between laptop 1111 and “side” restraints 1122; minimizing said space would thwart attempts to defeat 1122 by hacksaw increasing the chances of saw damage to the contained laptop thus reducing potential salability of the electronic article. The space between laptop 1111 and “side” restraints 1122 may be minimized by placing a spacer between “side” restraint 1122 and the enlarged portions (usually the ends) of lock 1123. Such spacers, in an alternative embodiment, may be applied around all, or a portion of, the circumference of the shaft of lock 1123 external to “side” restraints 1121 to force “side” restraints 1121 near to laptop 1111 thus minimizing gaps. Such spacers may include but not be limited to, washers, tubes, clamps, hollow conduits and nuts; such spacers may be made of hardened steel or alloys to resist tampering. Such spacers may also make it more difficult and time consuming to compromise the cage to steal the secured article, thus, further deterring theft.

The cavity of the body may be shaped to provide space below the laptop in which additional articles, such as wallet, mobile phone, camera, peripheral device for the laptop etc, may also be secured. It should be appreciated that once the laptop is secured within the cavity access is inhibited to the articles stored in one or more cavities below the laptop. Lids or covers may be provided for such cavities to ensure that very small articles, such as coins or jewelry, cannot slip out of the cavity and past the laptop if any space remains between the laptop and the sides of the cavity, which may be the case with very thin laptops.

In yet another embodiment, the system may be made larger to capacitate a desktop-PC by enlarging the mass, in conjunction with enlarging the “side” restraints to capacitate various sized desktop-PC units, with or without creating a depression in the mass to capacitate or surround a portion of the lowermost bottom portion of a desktop-PC, with or without enlarging the locking mechanism; if no desktop-PC fitting depression is made in the mass, the mass may also be depressed in areas sufficient to allow “side restraint” passage, and may also allow one or more slide bars passage beneath the desktop-PC to the mass's sequestered threaded insert and bolt. Other preferred types of “side” restraints may be of hardened steel, if added security is desired by consumers willing to bear the additional costs.

FIG. 12 depicts a frontal (and slightly L oblique) view of a plastic mold kit for personal making of a concrete mass in a ‘U’ shape as previously seen in FIG. 8C. A polymeric casing 1200 of, for example, polyester, polyethylene, nylon, or polypropylene, or some other hydrocarbon-based material, may be made in the form of a desired mass shape. A strong wire or other type of draw string 1201 may be incorporated into the polymeric mold in at least one circumference. To discourage multiple uses per mold, the drawstring may be located in a lower portion (such as lower third) of the mold.

Following appropriate hardening of the contained concrete, cement, or other hardenable liquid, the draw string may be pulled, thereby tearing open and releasing the contained shape. Pre-fabricated inward dimples 1202 in the surface of the mold may be used to form recipient fastening devices, such as threaded inserts 1271 (preassembled into mold by screwing or gluing to seal) so that the mold holds fast the fastener in position while the concrete mix dries.

Again, it may be beneficial if the inner dimple(s) matches the recipient site relatively closely so as to exclude significant concrete from entering and fouling the fastening device. The plastic mold could also act as its own container for dry cement lumps, granules, and powder whereupon after purchase the cement could be poured out of the mold, mixed with water or other ingredients such as cement-strengthening polymeric fibers 1203 (polypropylene, fiberglass, polyester, nylon, for example) and reinserted via larger pour holes 1204 in the gravitationally superior aspects of the intact mold. Smaller air vents 1206 at the top of the gravitationally seated mold may also be provided so as to allow cement to rise unrestricted by any pressurized air bubbles.

The insides of the mold may also be formed to give a wood or other grain-like appearance 1205. The inside of the mold may also be painted or pigmented in such a way that the pigments or paints would be imparted to the drying or setting concrete or cement surface.

Various embodiments disclosed herein may also be used to secure a laptop or another electronic article within a vehicle. For example, an eyebolt can be connected to seatbelt fixation hardware (often a recessed STEEL rod in a cup). Thus, for example, the eyebolt can be padlocked to the seatbelt fixation hardware with a hardened steel quality extended shackle lock.

In one embodiment, the system may have at least one threaded insert placed and hardened into the rear of the body at a lower edge of a shorter vertical side end of the body. Alternatively, threaded inserts may be placed in other surfaces of the body, preferably the lower regions of the body. In some embodiments, these inserts may be, positioned such that they are sufficiently spaced from the edges of the mass to resist removal by hammer chipping.

An appropriately sized eyebolt may be screwed into the matching sized threaded insert. A vehicle (bus, van, boat, etc) may also have fixedly attached thereto (by a mechanic or properly skilled individual) a seat belt anchor plate (for example, 80 mm×50 mm, 3 mm thick with 7/16 inch cap and nut). This may be, for example, attached to the floor and/or trunk of the vehicle. The plate may be riveted into the vehicle (preferably near the hump close to the front of a seat to reduce the ability to twist out the unit and reduce access for a hacksaw or bolt cutters). The eyebolt may then be screwed through the hole in the floor into the opposing side of the plate that is on the underside of the car. The eyebolt in the threaded insert of the mass may then be padlocked into the eyebolt of the seatbelt anchor plate.

The laptop embodiment may have at least one threaded insert 1490 placed and hardened into the rear of the mass at a lower edge of a shorter vertical side end of the mass, such as is shown in FIG. 14B, or another side. The threaded inserts may have an internal size of 10 mm for the threaded inner diameter, may have an outer dimension of 16 mm, and may have a depth of 35 mm. Alternatively, the threaded inserts may have an inner dimension of 12 mm, a depth of 50 mm, and an outer dimension of 18 mm. An appropriately sized eyebolt 1491 may be screwed into the matching sized threaded insert. The vehicle (bus, van, boat, etc) may also have fixedly attached thereto one or more modified seat belt anchor plates.

In one embodiment, a coupling mechanism may be provided, as shown in FIG. 13, which is configured to couple any of the electronic article/mass systems described herein to an external fixture. External fixtures may be any fixed, external (external to the electronic article/mass system) surface or object, such as a seat rail 1303 in a vehicle, a wall, a floor, or the like. The coupling mechanism shown in this figure comprises first and second coupling members, 1301 and 1302, respectively. The coupling mechanism is configured to block access to a fastening member 1320 that is used to connect the coupling mechanism to a fixed, external surface 1303. In the depicted embodiment, the first and second coupling members both comprise plates.

Thus, an inferior plate 1301 may be fastened over the seat rail 1303, preferably at the rear of the driver's seat or rear of the front passenger's seat, and be fastened as the seat rail bolt 1320 passes through a hole 1311 in the inferior plate and then through a hole 1313 in the seat rail and into the anchor point of the vehicle (not shown in the figure). The seat rail bolt 1320 may blocked, or at least made to be less accessible to tampering, by having a superior overlying plate 1302 overlaying the rail bolt head 1320. The superior plate 1302 may also have a hole 1312 to allow passage of an eyebolt 1324 through and into a hole 1321 in the inferior plate (which has a recipient nut 1322 awaiting on or about its underside), which may be affixed to the underside of the inferior plate by welding.

At least one protrusion 1332 from the superior plate may also be included to prevent motion that might uncover the seat rail bolt. Alternatively, a seat belt restraint plate may be riveted into the floor of the car (preferably near the hump close to the front of a seat to reduce the ability to twist out the unit and thereby reduce access for a hacksaw or bolt cutters). Alternatively, the trunk of the car may be chosen for attachment. The eyebolt may then be screwed through the hole in the floor into the opposing side of the plate that is on the underside of the car. The eyebolt in the threaded insert of the mass may then be locked, such as padlocked, together with the eyebolt of the seatbelt anchor plate or affixed seat railing plate. When properly positioned, such as next to a corner or edge, the size, shape, and/or mass of the system may help prevent rotation of the unit sufficiently to release either of the bolts or screws or threaded inserts so as to allow theft.

FIGS. 14A-E depict another embodiment that is particularly desirable for use in connection with securing laptop computers. The depicted system includes a vertically positioned laptop-PC 1411 that is releasably partially encased in an intermediary structure 1421, which is, in turn, attached to a body 1430. Body 1430 comprises superior portion 1431 and inferior portion 1432. In this embodiment, intermediary structure 1421 comprises a metallic or plastic cage, which is made up of two complimentary side restraints 1421. The intermediary structure 1421, may be fastened directly to body 1430 by fasteners (including threaded insert 1480 in a preferred embodiment and matching bolt 1481). Inferior portion 1432 may be thicker and more solid and may contain thicker reinforcing steel 1434. Superior portion 1431 may be partly hollow to capacitate article 1411, in this example a laptop-PC with surrounding slot 1415.

At least a portion of superior portion 1431 of the mass (or an object extending from the superior portion of the mass) surrounds a portion of the electronic article. Depending upon the shape of the embodiment, the “side” restraints 1421 may be permitted to pass in spaces 1434. The superior portion 1431 of the mass 1430 may contain reinforcing matter, preferably metal 1433, and, most economically, steel. In a preferred embodiment, bolt 1481 and threaded inserts 1480 may be positioned such that they are inaccessible in the presence of a space-occupying electronic article or laptop 1411. The “cage” in this embodiment may be comprised of two or more steel 8 mm×40 mm cross-sectional-dimensional “side” restraints 1421, some of which may be predrilled at the top end to accept a locking mechanism to lock in the laptop-PC. The bottoms of the side restraints may also be predrilled to allow for fixed or adjustable (via slots) attachment to the body's recipient threaded insert 1480 via bolt 1481. The term “side” here is used to indicate the side of the cage and body 1430 as a composite security unit and these “sides” may contact only the top and bottom surfaces of a laptop (as one refers to a laptop in its traditional position of sitting closed laying flat on a desk).

The side (really laptop-top and laptop-bottom) restraints 1421 in this embodiment may be bent in mirror images, both in the shape of an “L”, so that the bases of the “L's” may interlock or slide over one another to achieve a desirable ‘grip’ to the apparent sides (top and bottom) of the laptop. With a proper ‘grip,’ hacksawing a “side” restraint would likely damage the adjacent electronic article thus rendering it less saleable. Pre-drilling superiorly may be done in a plurality of holes 1422 (17 mm, for example) to accept a lock, such as a standard trailer lock, and accommodate varying laptop sizes. Pre-drilling at the bottom may be done as a slot or hole (13 mm, for example) to accept an appropriate fastener. A slide bar may be used to prevent movement of the laptop within the mass by restraining the rotation or movement of the laptop within the 1415.

Access to the binding mechanism, or as suggested in this example bolt 1481, between the laptop-PC cage may be provided only once the standard lock or trailer-hitch lock connecting two or more portions of the cage sitting atop the laptop has been unlocked and the laptop removed. A system is thus demonstrated wherein the presence of the electronic article impedes access to fastening hardware. More particularly, in the depicted embodiment, the presence of the electronic article renders inaccessible at least one of the fastening hardware pieces between the intermediary structure and the body. In an embodiment the threaded insert 1480 may extend through the body to enable the bolt 1481 or other binding mechanism to form part of the coupling mechanism for coupling the body to a fixture, for example the bolt 1481 may be adapted to be permanently screwed into the floor. Alternatively in such an embodiment the bolt 1481 may be substituted for a fastener, such as a U-bolt or strap, which can loop through or attach to a fixture such as a car seat rail. The fastener can then extend through the aperture 1480 into the cavity of the body to be secured, for example using a lock, bolt or screw. Thus, the presence of the laptop secured in the cavity will impede access to both the coupling mechanism and the binding mechanism. The fastener can form part of both the coupling mechanism for attaching the body to a fixture, and the binding mechanism for securing the intermediary structure. An advantage of this arrangement is that only one fastener needs to be released to remove and disassemble the system when it is not in use or to move the system to a different vehicle.

The base and/or sides of the ‘cage’ may have one or more predrilled holes allowing releasable attachment via, in this embodiment, a screw/bolt into a female threaded insert 1480, or inserts, which may be placed into hardening concrete, for example. An option exists to fortify the system even further for the customer; this option is more costly, but allows for reducing the ability of a saw to attack the cage. In one of the few regions where sawing may damage the contained PC the least, that being near the junction of the lock and holes 1422 of “side” restraint 1421, one or more reinforcing sleeves 1416 may be provided. In one embodiment, a hardened alloy sleeve 1416 may be adjustably or fixedly attached to one or more “side” restraints 1421. The hardened alloy sleeves 1416 may bear holes 1428 or portions of holes, and may be shaped to block perpetrator tool access or shift to thwart efficient tool movement or may be formed to partly cover portions of “side” restraints by slide-able (see possible slide path 1417), clip-able, clamp-able or other means. An example of a sleeve having four bends is illustrated in FIGS. 14c, 14d, and 14e, this sleeve 1416 wraps around the side restraint 1428 such that all surfaces of the side restraint are contacted by the sleeve. However, a sleeve having a U shaped cross section with only two bends is also envisaged. Such a sleeve may be lower in cost to produce than a four bend sleeve while still providing adequate additional protection. For example, if the side restraints are positioned such that to bend the sleeve would cause damage to the laptop. Examples of materials suitable for use in forming a reinforcing sleeve include boron, chromium, manganese, vanadium, carbon, tungsten, and titanium alloys.

As previously discussed, depending upon the shape of the embodiment, the “side” restraints may be permitted to pass in spaces 1434 of the mass 1430. Slot 1434 may be made to extend from portion 1431 into portion 1432, so as to allow greater positioning variability. A sufficiently large space differential between slot 1434 and “side” restraint 1421 may allow sleeve 1416 to slide freely along a path, such as 1417, such that the rim of the superior portion 1431 of the mass “protects” uncovered “side” restraint 1421, thus allowing a given length of sleeve 1416 to protect a wider variety of sizes of electronic articles while allowing hole 1428 to align with a hole chosen, such as 1422, through which to secure the entire system with a lock, such as a trailer lock.

In laptop embodiments, it may be desirable to have the cage closely approximate the width of the contained electronic article because such measures as hack sawing to defeat the security device would likely result in damaging the electronic article, thereby reducing salability. Electronic articles, especially laptops, are becoming progressively thinner. In one embodiment described above, the horizontal portions of the L's, when fastened onto the body, display an overriding/overlying L and an underlying/inferior L. This arrangement enables the distance between the two side restraints to be adjusted to accommodate different laptops. Once the fastener 1581 is tightened the side restraints are held in position at the appropriate width. The horizontal portions of the L-shaped side restraints may be slotted with a minimal dimension exceeding the width of the bolt used to fasten the L's to the mass's threaded insert, therefore the vertical portions of the two L-shaped side restraints can only come as close as the horizontal length of the overriding L (because the horizontal edge of the overriding L collides with the area adjacent the bend in the underlying L). In such an embodiment, a laptop thinner than the horizontal dimension of the overlying L, would show gaps between laptop and the ‘cage’ or side restraints (totaling the difference between the horizontal dimension of the overlying L and the thickness of the laptop).

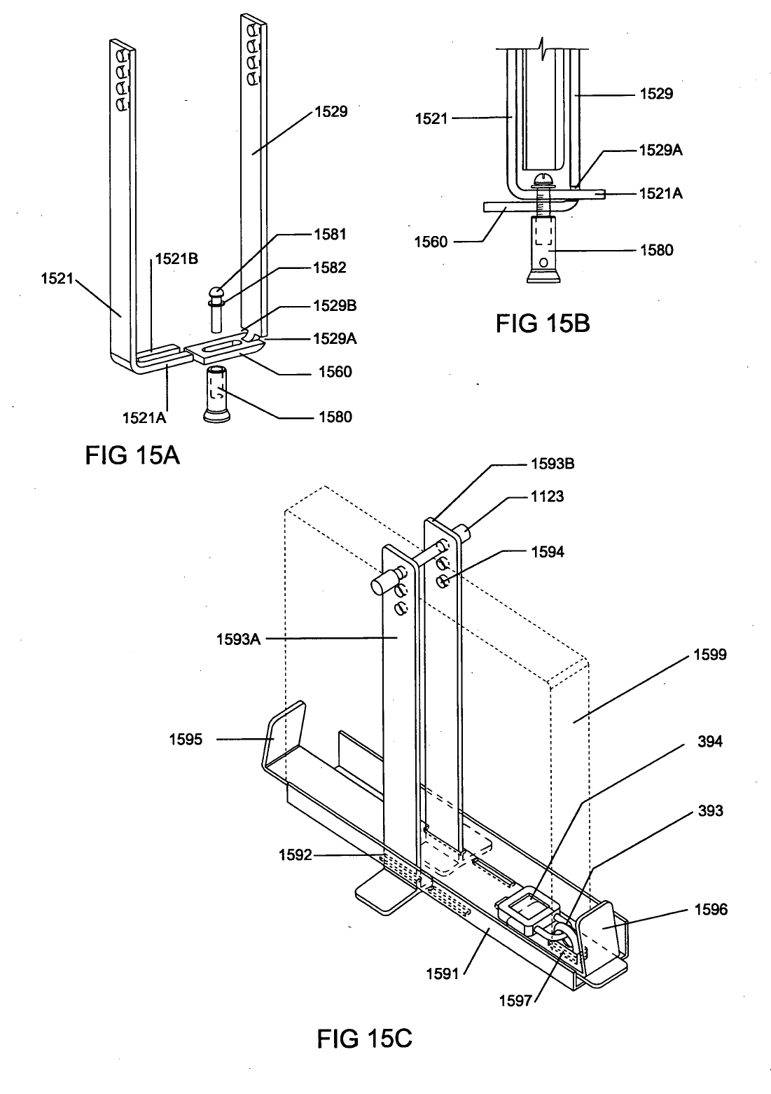

Because gaps between the electronic article and the cage may be undesirable, in alternative embodiment, to allow a tighter fit, modifications may be made in and/or near the horizontal portion of the L's. For example, as shown in the embodiment of FIGS. 15A and 15B, the horizontal portion of the overlying L or side restraint 1521 may have projections 1521A and 1521B that may pass through corresponding openings, 1529A and 1529B, respectively, in portions of the underlying L-shaped side restraint 1529.

Opposing side restraint 1529 also comprises a lower horizontal member 1560 which has a slotted opening 1561 formed therein. Thus, as the opposing L-shaped side restraints 1521 and 1529 are pushed toward each other prior to tightening of a fastener 1581, interference between side restraint 1529 and projections 1521A and 1521B does not occur. As also seen in these figures, fastener 1581 (along with, if desired, washer 1582) fits through slotted opening 1561 and is received within threaded insert 1580, as shown in FIG. 15B. The size of the gap formed between the upper portions of the two L-shaped side restraints 1521 and 1529 may be selectively adjusted by sliding the side restraints together and tightening fastener 1581 at a different location along slotted opening 1561.

FIG. 15C depicts another embodiment for use in connection with securing laptop computers. The depicted system includes a metal body 1591 attachable to an intermediary structure comprising two L-shaped shaped side rails 1593A+1593B and two rotation-torque inhibition rails 1595 and 1596. Body 1591 is preferably comprised of a ‘U’ shaped metal, preferably steel channel measuring 35 cm in length, 6.5 cm width, 2 cm in height and 3 mm in wall thickness. Symmetrical slots 1952 in base 1591 are cut to allow passage of siderails 1593A+1593B. Slots 1592 preferably measure 45 mm×6 mm and may capacitate and allow sliding of siderails of preferable cross sectional dimensions 40 mm×5 mm. Siderails 1593A+1593B are preferably metal of spring steel or saw-resistant alloy and measure 36 cm in length and may have one or more holes 1594 of sufficient diameter to capacitate cylindrical, preferably trailer, lock 1123. Siderails 1593A+1593B may be ‘L’ or ‘T’ shaped or may have an enlargement at one end to prevent passage about slot 1592. If ‘L’-shaped, the lower part of the ‘L’ preferably measures 4 cm. If ‘T’-shaped one smaller length preferably measures 4 cm and the other 2 cm.

Slots, holes or geometric defects 1597 are cut into the body 1591 to capacitate the passage of an eye of a floor-fastened eyebolt 393 or other fixture-fastened screw or bolt. For example, floor-fastened screws or bolts may be fastened into the floor by such methods as drop-in threaded anchors. Alternatively a U-bolt could be looped around a car seat rail or other fixture. A lock or fastener 394 can be applied to the eyebolt 393 or other fastener to couple the body to the floor or fixture. It should be appreciated that access to the fastener is inhibited by the presence of a laptop secured in place using the lock 1123. Slots or holes or geometric defects 1597 may match or align with similar slots or holes or geometric defects cut into torque inhibition rails 1595 and 1596. In an embodiment the hole 1597 may be aligned with the siderails such that a bolt used to fasten the body to the floor or a fixture further form part of the binding mechanism to secure the siderails in place. Thus securing the body to the floor or fixture and securing the siderails in place is performed using a single fastener or lock. Access to this lock or fastener is inhibited when the laptop is present and secured.

A series of slots or holes or geometric defects may be made in torque inhibition rails 1595 and 1596 to achieve adjustability to match a given laptop's size. It is preferable that one rail 1595 be longer (and receive more geometric defects) than the other 1596. 1595 may thus be slid under 1596 for adjustability in passage of eyebolt 393 (fastened to floor); eyebolt 393 can pass through the slot 1595 in the base as well as slots in 1595 and 1596 before being secured by lock 394. The laptop or electronic article bound into the aforementioned system by lock 1123 may overlie and protect a portion of lock 394. Torque inhibition rails 1595 and 1596 are preferably ‘L’-shaped and made of 5×50 mm spring steel and 1595 preferably measures 41 cm in longest limb by 6 cm in the shortest limb of ‘L’ while 1596 preferably measures 10 cm in longest limb by 6 cm in the shortest limb of ‘L’. Slots, preferably measuring 35×12 mm may releaseably accommodate a range of eyebolts.

FIG. 16A depicts another embodiment that is particularly desirable for use in connection with securing laptop computers. The depicted system includes an intermediary structure 1621, which is, in turn, attached to a body 1630. Body 1630 is comprised of a superior portion 1631 and inferior portion 1632. A hollow or well 1639 may be provided in or about the location of the internal threaded insert 1680. The hollow or well 1639 may be used to store peripheral devices. For example, flash drives and memory chips may be stored in the well 1693, obstructed by a laptop when locked in place.

In this embodiment, intermediary structure 1621 comprises a metallic or plastic cage comprised of two complimentary side restraints 1621 which may interlock with at least one adjustable wing 1623. Adjustable wing 1623 may be comprised of at least one, preferably metal structure capable of attaching releaseably or non-releaseably to one or more side restraints 1621. Adjustable wing 1623 may be made slideable within the base by cutting slots, as shown previously to fit with a complimentary adjustable wing or the bolt 1681 of threaded insert 1680. Adjustable wing 1623 may be made capable of attaching releaseably to one or more side restraints 1621 by cutting complimentary male and female shapes on or about the areas of attachment. One method, depicted, is complimentary squares wherein side restraint 1621 has a smaller peg welded on the inferior portion of 1621 with larger metal square-shaped obstruction/male portion 1627 welded on the opposing side of the smaller peg. Even larger square-shaped female/hole 1626 is punched or formed into adjustable wing 1623 to accommodate metal square obstruction/male portion 1627. It is desirable to have the orientation of square shapes between the adjustable wing's square male/obstruction and inferior side restraint's female/hole to be about 45 degrees difference.

A laptop may be more tightly fitted within the system in two ways: by placing padding (such as rubber) in the base under the computer to raise it; and by ensuring that the lock is passed through the lowest possible holes 1622 of side restraints. This fitting aims to limit the possible movement of the side restraints to less than the 45 degrees necessary to release the laptop unless the lock between holes 1622 is released. The sliding wing portion 1623 of the intermediary structure, may be fastened directly to body 1630 by fasteners (including threaded insert 1680 in a preferred embodiment and matching bolt 1681).

Again, at least a portion of superior portion 1631 of the body (or an object extending from the superior portion of the body) surrounds a portion of the electronic article. Depending upon the shape of the embodiment, the junction of “side” restraints 1621 and sliding wing 1623 is preferably hidden between a laptop and body, superior portion 1631, but, the junction may be located deeper in well 1639.

The sliding wings 1623 and 1624 in this embodiment may be bent to resemble mirror images, both in the shape of an “L”, so that the bases of the “L's” may interlock or slide over one another to achieve a desirable ‘grip’ to the apparent sides (top and bottom) of the laptop when side restraints 1621 are attached. In one embodiment described above, the horizontal portions of the L's, when fastened onto the body, display an overriding/overlying L and an underlying/inferior L. Again, this arrangement may enable the distance between the two side restraints to be adjusted to accommodate different laptops. Side restraints may again be fortified by using spring steel and alloys including but not limited to silicon, boron, chromium, manganese, vanadium, carbon, tungsten, and titanium alloys. Wings may be made of such strong materials, however common steel may be easier to forge or punch as are some plastics. Also in FIG. 16a, metal shields 1692a and 1692b, may be placed about or around eyebolts 1691 or eyescrews to reduce access to the lock by hacksaws, hammers, etc. Metal shields 1692a and 1692b, may be placed about or around eyebolts 1692 either passing over (1692a) the threads of the eyebolt (and being secured/sandwiched/compressed against the base mass) or passing over (1692b) the entire eye of eyebolt 1692 in a slotted fashion (and being restricted by the presence of the padlock shackle). Metal shields may be made of hardened spring steel for extra strength. Collared eyebolts are preferred fasteners if the base is concrete and eyescrews are preferred fasteners if the base is wood. Eyescrews may mimic the strength of a collared eyebolt when a metal sleeve sized appropriately is trapped between the eyescrew and the base on tightening of the eyescrew.

As shown in the embodiment of FIG. 16B, the horizontal portion of the overlying L or sliding wing 1623 may have projections 1621A and 1621B that may interdigitate with various spaces, 1629A and 1629B, respectively, in portions of the underlying L-shaped sliding wing 1624.

Opposing sliding wing 1624 also comprises a lower horizontal member 1660 which has a slotted opening 1661 formed therein. Thus, as the opposing L-shaped sliding wings 1623 and 1624 are moved toward each other prior to tightening of a fastener 1681, interference between side restraint 1624 and projections 1621A and 1621B does not occur. The size of the gap formed between the upper portions of the two L-shaped sliding wings 1623 and 1624 may be selectively adjusted by sliding the side restraints together and tightening fastener 1681 at a different location along slotted opening 1661.

As shown in the embodiment of FIG. 16C, the horizontal portion of a scored wing 1693 (which may have projections 1693A and 16936) may overlie or sit level with the opposing scored wing 1694 (which may have projections 1694A and 1694B). The wings may be scored or incised to create grooves that may serve more than one purpose including: allowing manual breakability using pliers so the customer can shorten the projections to match laptop size and allowance for increased resistance (or points of contact) between the projections and a washer 1682B or wing containment junction piece.

Wing projections 1693A and 1693B have slotted openings between them as do 1694A and 1694B. At least one dimension of a slotted opening preferably exceeds the width of fastener 1681 Said fastener releaseably attaches to threaded insert 1680 after passing through washer 1682B which may be bent or contain protruding elements that increase contact, friction or resistance with scores/incisions/grooves present on wings or wing projections. It is noteworthy, that regarding bent siderails, as mentioned in previous FIG. 15, that a bent siderail's projections may be scored similarly so the customer can break off portions to match a contained electronic article's size.

FIG. 16D is a side view of FIG. 16C showing identical scored wings 1693 that may sit level with the opposing scored wing. The wings may contain scores/grooves 1696 that may serve more than one purpose including: allowing manual breakability of a portion of the wing using pliers so the customer can shorten the projections to match laptop size and can allow increased resistance (or points of contact) between the projections of wing 1693 and wing containment junction piece 1682C which may also be a washer. Wing containment junction piece 1682C may be bent or contain protruding elements 1682d that increase contact, friction or resistance with scores/incisions/grooves 1696 present on wings. Fastener 1681 passes through wing containment junction piece 1682c and portions of wing 1693 before entering threaded insert 1680 which is, in turn, bound into base 1630. Although the overall shape of wing containment junction piece 1682c in this embodiment was of a flat plate with end protruding elements 1682d, the overall shape of wing containment junction piece 1682c may be curviform, angulate or geometric and may have protruding elements capable of enhancing contact with scores/grooves 1696.

In alternative embodiments the one or more securing members of the intermediary structure can include one or more flexible components, such as straps, bands, cables, chains etc. Such flexible components can be advantageous for adjusting the size and shape of the intermediary structure fit different laptop sizes or even to easily adjust the intermediary structure to enable a laptop within a protective sleeve, laptop bag or briefcase to be accommodated. For example, the securing member may comprise a strap made out of a material which is difficult to cut through without special tools, such as a combination of a fabric strap reinforced with spun metallic and/or Kevlar threads or cables. However, any suitably strong, non-elastic and difficult to cut material can be used. The securing member may have a rigid portion on at least one end adapted to cooperate with a locking mechanism to releasably attach the securing member to the mass, for example using a combination or key lock.

In some embodiments both ends of the securing member may be locked into the body, for example using a locking mechanism adapted to engage with both ends of the securing member within the body or cavity and having a single key or combination lock accessible by a user for locking and unlocking the securing member. Alternatively the securing member may be adapted to encircle the laptop and have both ends secured together outside the cavity, for example using a lock. In this embodiment the securing member is attached to the body using a binding mechanism within the cavity, such as a using bolt or other fastener similar to the embodiment illustrated in FIG. 14b. It should be appreciated that the flexibility of the securing member enables laptops of different widths to be accommodated and if the locking position for the securing member is adjustable, for example by providing a number of holes to enable the position of the lock to be adjusted to a selected hole or by providing a clamping lock adapted to lock the two ends of the strap together at any position, laptops of different sizes could be easily accommodated.

The securing member may be provided by a manufacture sized for a given laptop model or size. Alternatively the binding mechanism disposed within the cavity may be adapted to fasten the securing member selectively to enable a user to fit the securing member permanently or adjustably to fit a laptop. For example, for use with a strap the binding mechanism may include a fastener adapted to grip or clamp a portion of the strap to securely hold the strap with one end trailing within the cavity, the user can apply the fastener at a position on the strap selected so that the strap, when secured in the fastener and the lock, snugly fits the laptop. Where the fastener is releasable the user may adjust the position on the strap and thus increase or reduce the length of the trailing end to accommodate different laptops, or to accommodate the laptop within a protective sleeve, bag or briefcase. As the fastener is disposed within the cavity, presence of the laptop prevents access to the fastener. Permanent binding mechanisms such as staples or one way ratchet fasteners are also contemplated.

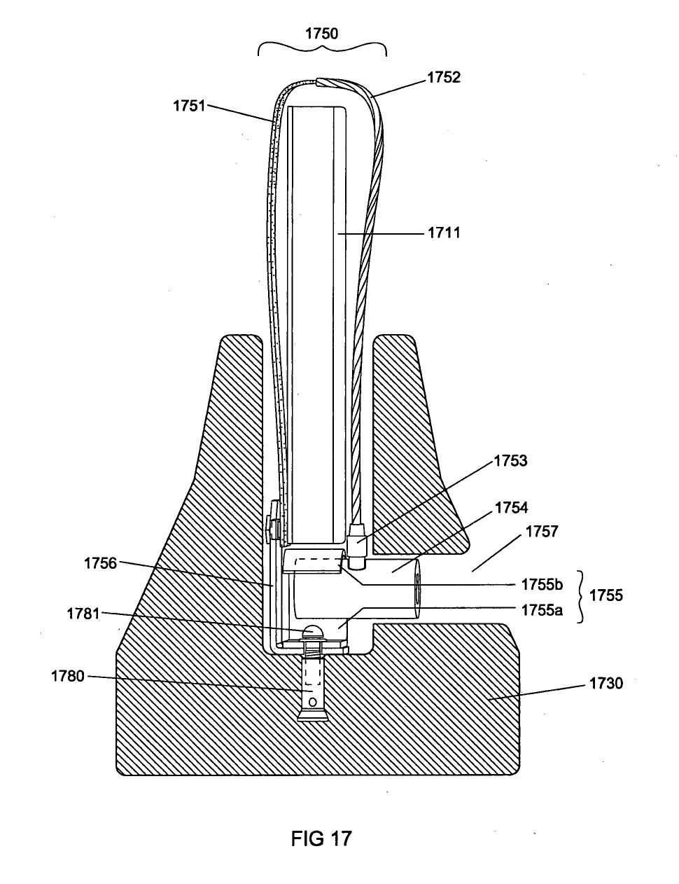

An example of one such alternative embodiment is illustrated in FIG. 17. The securing member of the intermediary structure of this embodiment comprises a flexible chain, cable, strap, band or mesh metallic restraint, which is, in turn, lockable or securable to the body 1730. FIG. 17 illustrates a vertically positioned laptop-PC 1711 releaseably encased in a flexible restraint 1750, which is fastened directly to body 1730 by fastener 1781 (bolt in the embodiment shown) into fasteners 1780 (threaded inserts in the embodiment shown). Threaded insert 1780 may be positioned such that locked attachment and associated hardware are inaccessible in the presence of a space-occupying laptop 1711.

The restraint 1750 of this embodiment may be comprised of one or more steel cables (for example, over 5 mm thick) or mesh or metal bands/straps (for example, over 2 mm thick and over 10 mm cross-sectional-dimensional). For illustrative purposes, both types of restraint are shown in FIG. 17 wherein one side is metal band/strap 1751 transitioning to metal cable 1752 as it passes over and restrains laptop 1711. However, the restraint may be all cable or all strap/band in alternative embodiments.

The bottom of the cable restraint 1752 is bound to a male locking portion 1753 which in turn may be releaseably secured into a lock 1754 (for example key-lockable cylinder bicycle lock type lock). Space 1757, preferably cylindrical, in base 1730 accommodates all or a portion of lock 1754. Lock 1754 may be further secured indirectly to base 1730 by bolt 1781 via the lower portion 1755a and the upper portion 1755b of lock restraint 1755. Lock restraint may be made out of shaped or bent steel preferably exceeding 2 mm thickness and 10 mm width. One terminus of band 1751 may also be secured into bolt 1781 by cable-band restraint 1756 which is preferably solid shaped metal exceeding 2 mm thickness and 10 mm width. The opposite portion of band or cable 1751 may be releaseably or non-releaseably bound to a terminus elsewhere in the base. The restraint may be trimmed or fitted to the laptop, alternatively a thumb screw or other releasable or adjustable binding mechanism may allow a portion of the cable or band restraint to pass through a portion of rigid metal cable-band restraint 1756 and be tightened into place. Any excess of cable or band could fit into a recessed area such as the hollow well depicted in FIG. 16 for convenience; the system could be modifiable should a different sized laptop need be protected in the base.

The above description fully discloses the invention including preferred embodiments thereof. Without further elaboration, it is believed that one skilled in the art can use the preceding description to utilize the invention to its fullest extent. Therefore, the examples and embodiments disclosed herein are to be construed as merely illustrative and not a limitation of the scope of the present invention in any way.

It will be obvious to those having skill in the art that many changes may be made to the details of the above-described embodiments without departing from the underlying principles of the invention. The scope of the present invention should, therefore, be determined only by the following claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in any country.

1-23. (canceled)

24. A system for securing an electronic article, the system comprising:
a moveable body;
an intermediary structure adapted to enable an electronic article to be secured to the body; and
a coupling mechanism to enable the body to be secured to an external fixture, wherein the body is shaped to inhibit unauthorized decoupling from the external fixture of the body and secured electronic article.

25. A system as claimed in claim 24, wherein the coupling mechanism comprises a first coupling integral with the body and a second coupling attachable to the first coupling and the external fixture.

26. A system as claimed in claim 25, wherein the first coupling includes a fastener which is cooperative with the second coupling.

27. A system as claimed in claim 25, wherein the first coupling fastener is a bolt fixed in the body and the second coupling is adapted to permanently or removably attach the bolt to the external fixture whereby the electronic article is secured to the external fixture.

28. A system as claimed in claim 27, wherein the second coupling is an irreversible fastener.

29. A system as claimed in claim 27, wherein the second coupling is a lock.

30. A system as claimed in claim 27, wherein the external fixture is an bolt fixed to a floor, wall, or permanently fixed furniture.

31. A system as claimed in 27, wherein the external fixture is a seat rail in a vehicle.

32. A system as claimed in claim 24, wherein the intermediary structure comprises:
a first surface adapted to be secured to the body using at least one first fastener; and
a second surface adapted to be secured to an electronic article using at least one second fastener in a manner which inhibits unauthorized removal of the secured electronic article without damaging the electronic article, wherein the intermediary structure is configured to impede access to both the first and second fasteners when the movable body and electronic article are secured to the first and second surfaces respectively.

33. A system as claimed in claim 32, wherein the first surface of the intermediary structure includes one or more first holes and the second surface includes one or more second holes wherein at least one of the one or more second holes is aligned with at least one or more first holes.

34. A system as claimed in claim 24, wherein the intermediary structure comprises at least one securing member, and the body includes a cavity configured to receive at least part of the intermediary structure and at least part of the electronic article and wherein at least one securing member of the intermediary structure is secured to the body within the cavity using a binding mechanism whereby the presence of the electronic article within the cavity renders the binding mechanism inaccessible, and wherein the intermediary structure is adapted to releasably secure the electronic article within the cavity.

35. A system as claimed in claim 34, wherein the intermediary structure includes two or more securing members in the form of side restraints adapted to be locked to form a cage to secure the electronic article within the cavity.

36. A system as claimed in claim 35, wherein each of the side restraints is substantially L-shaped.

37. A system as claimed in claim 36, wherein a first side restraint of the side restraints comprises at least one projection and wherein a second side restraint of the side restraints comprises an opening configured to receive the at least one projection.

38. A system as claimed in claim 35, wherein the side restraints are collapsible such that they may be selectively extended above the body.

39. A system as claimed in claim 24, wherein the intermediary structure comprises at least one securing member secured to the body wherein the intermediary structure is adapted to releasably secure the electronic article to the body, and the body is configured to receive at least part of the intermediary structure, at least part of the electronic article and the coupling mechanism to enable the body to be secured to an external fixture, whereby the presence of the electronic article secured to the body within the cavity renders access to the coupling mechanism inaccessible.

40. A system as claimed in claim 39, wherein the coupling mechanism further forms part of the binding mechanism whereby the intermediary structure is secured to the body, such that the presence of the electronic article secured to the body within the cavity renders access to the binding mechanism and coupling mechanism inaccessible.

41-45. (canceled)

46. A system for securing an electronic article, the system comprising:
a substantially U-shaped base comprising first and second slots and at least one fastener opening;
a first torque inhibition rail positioned adjacent to the base and comprising at least one fastener opening, wherein the first torque inhibition rail is configured to at least partially block an opening defined by the base;
a second torque inhibition rail positioned adjacent to the first torque inhibition rail and comprising at least one fastener opening, wherein the second torque inhibition rail is configured to at least partially block an opening defined by the base, and wherein the fastener openings of the base, the first torque inhibition rail, and the second inhibition rail are configured to be aligned to allow for passage of a fastener or external fixture therethrough;
a first siderail received in the first slot and comprising at least one lock hole configured for receiving a portion of a locking mechanism therethrough, wherein a portion of the first siderail is configured to prevent passage through the first slot; and
a second siderail received in the second slot and comprising at least one lock hole configured for receiving a portion of a locking mechanism therethrough, wherein a portion of the second siderail is configured to prevent passage through the second slot, and wherein the at least one lock hole of the second siderail is configured to be aligned with the at least one lock hole of the first siderail such that a single locking mechanism can extend through both siderails to secure an electronic article therebetween.

47. The system of claim 46, wherein the first and second torque inhibition rails are substantially L-shaped, and wherein the first and second siderails are substantially L-shaped.

48. A system for securing an electronic article, the system comprising:
a base comprising at least one fastener opening;
at least one siderail connected to the base and comprising at least one lock hole configured for receiving a portion of a locking mechanism therethrough; and
at least one torque inhibition rail configured to at least partially block an opening defined by the base, wherein the at least one torque inhibition rail comprises at least one fastener opening, wherein the at least one base fastener opening is configured to be aligned with the at least one torque inhibition rail fastener opening, and wherein the system is configured to confine an electronic article within a structure defined by the base, the at least one siderail, and the at least one torque inhibition rail.

49. The system of claim 48, wherein the base is substantially U-shaped.

50. The system of claim 48, wherein the base comprises at least one slot.

51. The system of claim 50, wherein the siderail is received in the at least one slot.

52. The system of claim 51, wherein a portion of the at least one siderail is configured to prevent passage of the siderail completely through the at least one slot.

53. The system of claim 48, wherein the torque inhibition rail is substantially U-shaped such that the torque inhibition rail at least partially blocks two openings defined at opposite ends of the base.

54. The system of claim 48, further comprising a second torque inhibition rail configured to at least partially block a second opening defined by the base.

55. The system of claim 54, wherein the second torque inhibition rail is positioned adjacent to the at least one torque inhibition rail.

56. The system of claim 55, wherein the second torque inhibition rail comprises at least one fastener opening, and wherein the fastener openings of the base, the first torque inhibition rail, and the second torque inhibition rail are configured to be aligned to allow for passage of a fastener or external fixture therethrough.

57. The system of claim 48, further comprising a second siderail comprising at least one lock hole configured for receiving a portion of a locking mechanism therethrough.

58. The system of claim 57, wherein the base comprises a second slot, and wherein the second siderail is received in the second slot.

59. The system of claim 58, wherein a portion of the second siderail is configured to prevent passage of the second siderail completely through the second slot.

60. The system of claim 59, wherein the at least one lock hole of the second siderail is configured to be aligned with the at least one lock hole of the first siderail such that a single locking mechanism can extend through both siderails to secure an electronic article therebetween.

61. The system of claim 60, further comprising a second torque inhibition rail.

62. The system of claim 61, wherein the first and second torque inhibition rails are substantially L-shaped.

63. The system of claim 62, wherein the first and second siderails are substantially L-shaped.
